(19) United States
(12) Patent Application Publication
(10) Pub. No.: US 2004/0047765 A1
(43) Pub. Date: Mar. 11, 2004

(54) Automated robotic workstation and methods of operation thereof

(76) Inventors: Steven J. Gordon, Weston, MA (US); A. David Boccuti, Arlington, MA (US); David Brancazio, Cambridge, MA (US); Steven Grenier, Arlington, MA (US); Kenneth Hathaway, Attleborough, MA (US); Edward Barrett, South Weymouth, MA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 10/306,787

(22) Filed: Nov. 27, 2002

Related U.S. Application Data
(63) Continuation of application No. 10/179,916, filed on Jun. 24, 2002.
Application No. 10/179,916 is a continuation of application No. 09/419,179, filed on Oct. 15, 1999, now abandoned.
(60) Provisional application No. 60/417,025, filed on Oct. 8, 2002.
(60) Provisional application No. 60/110,605, filed on Dec. 2, 1998.
(60) Provisional application No. 60/104,617, filed on Oct. 16, 1998.

(51) Int. Cl. B01L 3/02

(52) U.S. Cl. 422/63; 422/100; 422/104

(57) ABSTRACT

The invention provides an automated workstation capable of continuous, non-stop processing of specimens. The workstation includes a storage area that holds multiple cassettes containing specimens compounds or other materials to be analyzed or used in conjunction therewith (collectively, “specimens”) which, preferably, are maintained on slides, microliter plates, or the like (collectively, “plates”). The workstation also includes a robotic arm for processing the specimens, e.g., by grasping the plates, moving them from the cassettes to other apparatus contained within the workstation, and placing the plates back in the cassettes. The invention also provides methods and apparatus for acquiring and processing samples in narrow, thin-walled pipettes without transferring them to wells, vials, or other reaction vessels.

### REFERENCE TO RELATED APPLICATIONS

This application claims the benefit of priority of U.S. Provisional Patent Application Serial No. 60/417,025, filed Oct. 8, 2002. This application is a continuation in part of U.S. patent application Ser. No. 10/179,916, filed Jun. 24, 2002, which is a continuation of U.S. patent application Ser. No. 09/419,179, filed Oct. 15, 1999, which claims the benefit of priority of U.S. Patent Application Serial Nos. 60/110,605, filed Dec. 2, 1998, and 60/104,617, filed Oct. 16, 1998.

### BACKGROUND OF THE INVENTION

This invention relates to the automated processing workstations and, more particularly, to systems and apparatus providing the continuous processing of specimens and compounds. The invention has application in the testing, synthesis and processing of biological samples, chemical compounds, and the like.

Biological and chemical laboratory work has traditionally been performed by scientists and technicians manually. The growth of the pharmaceutical industry and, more recently, of biotechnology has increased demands for throughput and accuracy beyond that which can be met by manual techniques. Robotics equipment makers have responded with automated workstations that now handle many of the testing functions and that, in the near future, stand to take over the bulk of synthesis.

Designs of the prior art workstations vary dramatically. U.S. Pat. No. 5,443,791, for example, discloses an automated laboratory system, with a “Cartesian” robotic arm that employs separate gear belts for driving respective x-axis and y-axis carriages. A motorized rack-and-pinion drive positions a z-axis “carriage” on which a pipette tip and other processing components are mounted. An electrical probe extending from the z-axis carriage is used to calibrate the arm position each time an analysis protocol is performed. A wash station provided at a fixed location within reach of the robotic arm is used to clean the pipette tip.

U.S. Pat. No. 5,455,008 discloses a robotic DNA sequencing system in which a robot arm is slidably mounted for radial motion on a housing that moves vertically on a shaft. The shaft, itself, is attached to a swivel plate for angular rotation. A “hand” attached to the arm is used to carry specimen-containing microliter plates from refrigerated storage compartments to a work surface. To compensate for inadequacy in arm control, force sensors are utilized to sense and prevent breakage of pipette tips that are also attached to the arm.

U.S. Pat. No. 4,271,123, on the other hand, suggests the use of a rotating disk to present vials to an aspiration arm that withdraws samples for purposes of performing automated fluorescent immunoassays. Wash fluid is siphoned from a separate, stationary rinse container to wash the test assembly.

U.S. Pat. No. 4,835,707 discloses an apparatus for automatic analysis of enzyme reactions that utilizes an articulated robot arm equipped with an end-mounted chuck to grasp and move objects, such as sample tubes, reaction tubes and pipettes. An apparatus for transferring fluids to microliter trays wells, according to U.S. Pat. No. 4,554,839, has a horizontally indexable tray to position the wells under a head containing pipette tips. U.S. Pat. No. 4,730,631 discloses a stationary washing station that is used to clean an automated workstation probe tip without splashing.

Notwithstanding the foregoing, several challenges remain for automated workstation designers. As the competition increases to create new pharmaceuticals, for example, buyers demand workstations that can accommodate longer processing runs with greater numbers of specimens, yet, without degradation of accuracy. With the skyrocketing cost of laboratory space, they also demand workstations that are as compact as possible.

A goal of this invention, accordingly, is to provide such workstations and methods for operation thereof.

A more particular object is to provide an automated workstation capable of continuous, high throughput and high accuracy in processing of biological, chemical and other specimens and compounds.

A related object of the invention is to provide a high-capacity automated workstation that has a relatively small “footprint” and that does not consume undue space.

Another object of the invention is to provide improved methods and apparatus for identifying, grasping and moving specimens within an automated workstation. A related object of the invention is to provide improved methods and apparatus for translating a robotic arm within an automated workstation. Another related object of the invention is to provide improved methods and apparatus for positioning pipettes and other processing apparatus that are contained on a robotic arm.

Yet another object of the invention is to provide improved methods and apparatus for flushing or rinsing containers (e.g., slides, plates or trays) that hold specimens processed within an automated workstation. A related object is to provide methods and apparatus for flushing or rinsing pipettes and other processing apparatus that are carried on a robotic arm within such a workstation.

Still a further object of the invention is to provide improved methods and apparatus for detecting the presence or levels of fluids contained within pipettes and other processing apparatus carried on a robotic arm within an automated workstation.

Still another object of the invention is to provide improved methods and apparatus for processing chemical, biological and other samples. A further object is to provide such methods and apparatus as facilitate the processing of samples in small volumes. A still further object is to provide such methods and apparatus as permit the processing of samples with high throughput.

### SUMMARY OF THE INVENTION

The foregoing objects are among those attained by the invention, which provides in one aspect an automated workstation capable of continuous, non-stop processing of specimens. The workstation includes a storage area that holds multiple cassettes containing specimens compounds or other materials to be analyzed or used in conjunction therewith (collectively, “specimens”) which, preferably, are maintained on slides, microliter plates, or the like (collectively, “plates”). The workstation also includes a robotic arm for processing the specimens, e.g., by grasping the plates, moving them from the cassettes to other apparatus contained within the workstation, and placing the plates back in the cassettes.

The multiple cassettes themselves are removably disposed within the storage area so that they can be placed in and removed from the workstation by a scientist, laboratory technician or other workstation operator. An interlock mechanism prevents the operator and robotic arm from simultaneously accessing a cassette. This prevents operator or equipment injury and, thereby, facilitates continuous processing, e.g., of specimens contained in other cassettes in the storage area.

According to related aspects of the invention, external panels cover the storage area to protect the specimens and to prevent the operator from slidably inserting or removing cassettes. Internal panels likewise maintain the specimen storage environment and prevent the robotic arm from manipulating plates within the cassettes. The interlock mechanism prevents the operator from opening the external panel covering a given cassette and/or moving a cassette therein when the internal panel for that same cassette is open or if the robotic arm is otherwise accessing a plate therein. The interlock mechanism can additionally and conversely prevent the robotic arm or its control circuitry from opening the internal panel covering the plates within a cassette when the external panel for that cassette is open.

Further aspects of the invention provide an automated workstation of the type described above in which the specimen storage area is environmentally maintained, e.g., refrigerated. To this end, environmental control apparatus generates cooled, warmed, humidified, dehumidified or other environmentally controlled air (or other such gas or fluid) which is passed to the storage area, e.g. through vias or holes in a workstation wall separating the storage area from the environmental control apparatus. The aforementioned cassettes are constructed with open or partially open sides in order to permit that air to contact the plates and/or specimens.

Still further aspects of the invention provide an automated workstation of the type described above including a work area in which transfer stations, laboratory equipment and further pieces may be maintained for use in manipulating and processing the specimens or specimen plates. External access panels, preferably, separate from those described above, provide access to the work area for installation and removal of such pieces. The work area can be disposed adjacent to the cassette storage area. If two or more storage areas are provided (as is the case in preferred aspects of the invention), those storage areas are conveniently disposed at the periphery of the work area.

Yet still further aspects of the invention provide an automated workstation of the type described above in which the robotic arm is disposed on a track above the work area (and, optionally, above the cassette storage area). A belt drive mechanism of the type described below utilizes a single integral belt to position the arm in the x-axis and y-axis directions, e.g., to move it adjacent to the storage area for accessing a plate therein and to move it over apparatus in the work area to deposit the plate thereon.

To attain compactness and economy of motion, the arm can include both motor driven and pneumatically extensible sections to position “effectors,” e.g., plate grippers, plate rinse mechanisms, probes, pipettes and other such processing apparatus, in the z-axis direction. In one aspect of the invention, for example, a motor disposed on a frame of the arm turns a lead screw within a “nut” disposed on a carriage that, itself, is positioned along the x and y-axes via the aforementioned belt drive. A pneumatic section, which is mounted on the frame and which also moves as the lead screw is turned, can be extended to increase the reach of the arm. In operation, the motor-drive and pneumatic sections can be extended to enable a plate contained in a lower-most portion of the storage area to be gripped, and they can be retracted to permit that plate to be deposited on the top of processing apparatus in the work area.

A workstation as describe above can also utilize a plate identification mechanism to facilitate continuous processing. A detection mechanism disposed on the robotic arm can be used to identify cassettes or plates in the storage area. In one aspect of the invention, for example, “bar code” labels are attached to each specimen plate to identify them and, optionally, to indicate their type and contents. A bar code reader disposed on the pneumatically extensible section of the robotic arm is used to “inventory” the plates prior to, or in the midst of, processing. As a consequence, the workstation is capable of automatically identifying and properly handling plates inserted into the storage area during processing operations.

The effector can include fixed, telescoping or otherwise extensible forks for engaging a plate from the side, and grippers for engaging a plate from the top. Use of the forks enables the arm to remove plates from, or plates in, the cassette where they are closely stacked. The forks can also be used to move the plates to/from side-loading processing apparatus in the work area. For top-loading processing apparatus, the grippers can be used. To this end, according to one aspect of the invention, the forks are employed to retrieve a plate from a cassette and to deposit the plate on a transfer station disposed in the work area. The arm is repositioned above the plate and the grippers are employed to transfer it to the top-loading apparatus.

Still further aspects of the invention provide a workstation and/or robotic arm of the types described above with pipette-type effectors with back-flushing apparatus. According to these aspects of the invention, plungers that are normally used to expel fluids from the pipettes are backed out to permit a pressurized wash fluid, provided through vias in the effector mounts, to flush over the plungers and through the barrels and tips. In a related aspect of the invention, a valve disposed at the via outlet can be closed, forcing the pressurized fluid through the barrels and tips with greater force.

Still further aspects of the invention provide a workstation and/or robotic arm of the types described above with apparatus for rinsing the ends of effectors such as pipettes and probes. To this end, a wash cup is disposed on the robotic arm or, preferably, on mounts of the desired effectors themselves. Between processing operations, the wash cup is rotatably or otherwise positioned into a working position over the effector tip. Wash fluid is pumped through the tip (via the back flushing mechanism described above) into the cup to effect cleaning. The wash cup, according to further aspects of the invention, can include a plate rinse port for directing wash fluid onto a plate disposed below the effector.

Use of “on board” tip wash, plate rinse and back-flush mechanisms of the types described above contribute further to the compactness and throughput of the workstation by eliminating the prior art requirement for the use of stand-alone wash stations disposed within the work area.

Still yet further aspects of the invention provide a workstation and/or robotic arm of the types described above with apparatus for monitoring the fill levels of pipette-type effectors. A light source, such as an LED, disposed on one side of a pipette is detected by a photodetector at the other side. By monitoring the output of the photodetector, the fill level of the pipette can be determined. Such mechanisms contribute to the accuracy and throughput of the workstation by facilitating detection of pipette “misfires.”

In still further aspects, the invention provides methods and apparatus for acquiring and processing samples in narrow, thin-walled pipettes without transferring them to wells, vials, or other reaction vessels. Since the samples remain enclosed inside these “nano” pipettes, their volumes can be carefully controlled without fluctuations due to factors such as evaporation. This allows the processing of samples as small as a few nanoliters. Moreover, utilization of such narrow, thin-walled reaction vessel(s) permits the external stimulus to be uniformly and precisely applied to the samples.

In yet another aspect, the present invention provides automated workstations as described above having robotic arm with effectors that include one or more narrow, thin walled pipettes as described above for processing small volume biological and chemical samples. Such processing includes, but is not limited to, thermal, magnetic, radioactive and mechanical manipulation.

In one aspect, small volume fluid samples are thermally processed by aspirating them into the thin-walled pipettes using a close-fitting plunger. More than one sample may be aspirated into the pipettes and mixed by moving the plunger back and forth repeatedly. The samples are thermally processed by placing the pipettes in one or more thermally controlled environments such as an oven, cooler, air stream, fluid stream, or solid block. For example without limitation, such thermal processing can be used as part of an overall methodology for effecting polymerase chain reaction and for DNA sequencing reactions.

In yet another aspect, the present invention provides for a narrow thin-walled pipette as described above that includes a close-fitting plunger slidably disposed within its inner diameter or chamber. The plunger may either have a moving seal to the inside walls of the chamber or have a close fit that restricts the flow of air and acts as a seal. The end of the chamber opposite the plunger may optionally be fitted with a metal tip of a smaller diameter to aid in fluid aspiration and dispensing.

Still other aspects of the invention provide methods of operating automated workstations of the types described above. While yet other aspects of the invention provide robotic arms, robotic arm positioning mechanisms, plate handling mechanisms, effector tip/plate washing mechanisms, back-flushing mechanisms, fluid level detection mechanisms, and narrow thin walled pipettes of the types described above, as well as methods for operating the same.

Other aspects of the invention provide plate-handling or other effectors (e.g., of the types described above) that are coupled to a robotic arm, e.g., via mating of an elongate “quick connect” rod or other member on the effector with a latch or other member on the arm—or vice versa. A release exerts a torque on the effector at least partially countering a torque exerted on the mating members, for example, by the weight of the plate (or other article carried by the effector) and/or the weight of the structures that make up the effector (e.g., extending arms). The release facilitates disengaging the mating members and, thereby, detaching the effector from the arm.

Related aspects of the invention provide an effector as described above in which the release comprises a member that stands proud of a surface of the effector (or arm) and that exerts a force on the arm (or effector). The member can be, for example, spring-loaded and disposed opposite the mating member/latch from the weight that effects the torque being countered.

Further aspects of the invention provide a carrier for transport and/or processing of narrow, thin-walled, small-volume pipettes as described above. The carrier includes a first plate (or other member) in which a plurality of pipettes are disposed and a second plate (or other member) in which a plurality of corresponding plungers are disposed. The first plate is coupled for movement with respect to the second plate, which movement causes ends of the plungers to move in and/or out of the nanopipettes, e.g., to facilitate expelling and/or drawing samples.

Related aspects of the invention provide a carrier as described above in which one or more further plates (or other members) are disposed between the first and second plates. Those further plates include apertures which are aligned with the nanopipettes and their corresponding plungers and in which the plungers are disposed. The apertures are sized to permit the plungers to slide without buckling and/or without adversely impacting their positioning relative to the nanopipettes.

Further related aspects of the invention provide a carrier as described above in which the first plate includes an internal plenum in which proximal ends of the nanopipettes are disposed (e.g., within ferrules that are seated within corresponding recesses in the plate). Fluid lines can supply and/or remove wash fluid to/from the plenum for rinsing the ends of the nanopipettes and/or plungers. That fluid can also be used, for example, to flush the nanopipettes.

Still further aspects of the invention provide an effector, e.g., for mounting on a robotic arm as described above and for use with a carrier as described above. The effector includes a linear drive mechanism that is coupled to the first plate of the carrier. Its chassis (or another portion of the effector) is coupled to the carrier's second plate. Actuation of a motor in the drive mechanism causes movement of the first plate relative to the second plate, thereby, pushing the plungers (further) into their respective nanopipettes and/or pulling them therefrom.

Still further aspects of the invention provide a processing station for use in an automated workstation or otherwise, e.g., with a carrier of the type described above, to process nanopipettes and/or specimens contained therein. Such a processing station includes a housing defining a cavity providing a controlled environment for the nanopipettes when a carrier, e.g., of the type described above, is seated on the station. A gasket or other sealing member can be provided within the cavity to seal the distal tips of the nanopipettes. This can prevent undesired ingress/egress of specimens, fluid or gas to/from the nanopipettes during processing within the station. The sealing member can be sized to permit nanopipettes to sit at multiple registration positions, e.g., indexed by mating pins and/or registration holes in the carrier and/or station, thereby facilitating reuse of the sealing member.

Related aspects of the invention provide a processing station of the type described above adapted for washing and/or flushing nanopipettes held by a carrier, e.g., of the type described above. Such a wash station can have, e.g., in place of the sealing member, a set of apertures arranged to receive distal tips of the set of nanopipettes. Those apertures can be sized to permit slidable reciprocation of the nanopipettes tips with sufficient depth to facilitate (i) wash fluid to be drawn or forced into the respective nanopipettes via their tips, and/or (ii) wash fluid to rinse the tips, e.g., to remove contaminants.

Still further related aspects of the invention provide a processing station of the type described above adapted for thermal cycling of nanopipettes held by a carrier, e.g., of the type described above. Such a thermal cycling station can include a heater, fan, baffles and/or thermocouple arranged, e.g., about a core of the station, to ensure turbulent mixing of heated and/or cooling air, such that the nanopipettes are exposed to equi-temperature air flow.

Yet still further aspects of the invention provide workstations and/or robotic arms of the types described above with apparatus for rinsing the tips of pipettes or flushing their interiors. Such apparatus includes a plurality of apertures sized to permit slidable reciprocation of the tips with sufficient depth to facilitate (i) wash fluid to be drawn or forced into the respective nanopipettes, and/or (ii) wash fluid to rinse the tips themselves, e.g., to remove contaminants. Such apparatus and/or an arm on which it is disposed can be rotated into alignment with the tips and moved into contact with them, e.g., via action of a pneumatic element or otherwise. A wash fluid can then be introduced into the apparatus for washing the tips and/or flushing the nanopipettes.

Still further aspects of the invention provide methods of processing chemical and biological or other samples paralleling the operations and/or using the apparatus described above. Still further aspects of the invention are set forth in claims-like language below:

Spring-Loaded Release Claims

1. In a robotic arm of the type having an effector that is detachably coupled to the arm via a latching mechanism that includes first portion disposed on the effector and a second portion disposed on the arm, the improvement comprising

a release at least one of (i) disposed on the effector separately from the first portion of the latching mechanism and (ii) disposed on the arm separately from the second portion of the latching mechanism,

the release effecting a torque on at least one of the first and second portions of the latching mechanism at least partially countering a torque effected on that portion of the latching mechanism by at least one of the effector and an article carried thereby.

2. In the robotic arm of claim 1, the further improvement wherein the release effects a torque tending to bring the first and second portions of the latching mechanism into alignment for disengagement.

3. In the robotic arm of claim 1, the further improvement wherein the release comprises a rod that stands proud from a surface of any of the arm and effector.

4. In the robotic arm of claim 3, the further improvement wherein the rod is spring-loaded.

5. An effector for use with a robotic arm, the effector comprising

one or more extending forks adapted for handling a specimen or vessel therefor,

a first latching member adapted for releasable engagement with a second latching member on the arm,

a release disposed separately from the first latching member, the release adapted for exerting a force on the arm when the first and second latching members are engaged, the force effecting a torque on the first latching member that at least partially counters a torque effected on that member by at least one of the forks, the specimen, and a vessel therefor.

6. The effector of claim 5, wherein the first latching member comprises an elongate element adapted for releasable engagement by an element on the arm.

7. The effector of claim 5, wherein the release comprises a spring-loaded element.

8. The effector of claim 5, wherein the release comprises a rod that stands proud from a surface of the effector.

9. The effector of claim 5, wherein the release is disposed opposite the first latching member with respect to forks.

10. The effector of claim 5, wherein the release effects a torque that brings the first and second latching members into alignment for disengagement.

11. An effector for use with a robotic arm, the effector comprising

structure adapted for handling a specimen or vessel therefor,

an elongate element adapted for releasable engagement with a latch or other actuator (collectively, “latch”) on the arm,

a release member disposed separately from and independent of the elongate element on an opposite side thereof with respect to the aforesaid structure,

the release member adapted for effecting a torque at least partially countering that effected on the elongate element by the structure or a specimen or vessel handled thereby and, thereby, facilitating release of any engagement therebetween.

12. The effector of claim 11, wherein the release comprises a spring-loaded member disposed on a surface of the effector.

13. The effector of claim 12, wherein the first latching member comprises a rod that stands proud from a surface of the effector.

14. The effector of claim 12, wherein the surface of the effector is one that mates with a surface of the arm.

15. In an automated workstation, the improvement comprising a robotic arm including

a moveable member,

a pneumatic latch or actuator (collectively, “pneumatic latch”) disposed on the moveable member,

an effector,

the effector comprising

a load-carrying structure,

a latching member adapted for releasable engagement with the pneumatic latch,

a release member disposed separately from the latching member,

the release member exerts on the latching member a torque that at least partially counters that effected on the latching member by the load-carrying structure or a load carried thereby.

16. In the automated workstation of claim 15, the further improvement wherein moveable member is coupled to an assembly capable of translating the moveable member in at least two dimensions.

17. In the automated workstation of claim 16, the further improvement wherein the load-carrying structure comprises one or more extending forks.

18. In the automated workstation of claim 16, the further improvement wherein

the latching member comprises an elongate element,

the release member exerts a torque tending to bring the elongate element into line with the pneumatic latch.

19. In the automated workstation of claim 16, the further improvement wherein the release comprises a spring-loaded member.

20. In the automated workstation of claim 19, the further improvement wherein the spring-loaded member stands proud from a surface of the effector.

Nanopipette Tip Wash Mechanism

21. In a robotic arm, the improvement comprising

a wash apparatus comprising one or more apertures, each arranged for receiving one or more respective tips disposed on the arm,

the wash apparatus translating from a first, carrying position in which the apertures are disposed clear of the respective one or more tips to a second, operative position in which the one or more tips are received in the one or more apertures,

such translation of the wash apparatus including rotating from the first position to a third, intermediate position and moving linearly from the third position to the second position.

22. In the robotic arm of claim 21, the further improvement wherein, when the wash apparatus is in the third position, each of the one or more apertures are aligned with one or more respective tips which are to be received therein.

23. In the robotic arm of claim 21, the further improvement wherein the tips are pipette tips and wherein the one or more apertures are arranged for receiving such pipette tips.

24. In the robotic arm of claim 23, the further improvement wherein at least one of the apertures is arranged for receiving the tip of a pipette comprising a thin-walled cylindrical chamber with a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

25. In the robotic arm of claim 21, the further improvement wherein the wash apparatus comprises at least one of an ingress and egress for wash fluid.

26. In the robotic arm of claim 21, further improvement wherein the wash apparatus is disposed on an actuator for motion relative to the tips.

27. A pipetter for use with the robotic arm, comprising

a plurality of pipettes, each having a tip,

a wash apparatus disposed for motion relative to at least the tips, the wash apparatus comprising a plurality of apertures, each arranged for receiving a respective pipette tip,

the wash apparatus translating from a first, carrying position in which the wash apparatus and the apertures are disposed clear of the tips to a second, operative position in which the tips are received in the respective apertures, such translation of the wash apparatus including rotating from the first position to a third, intermediate position and moving linearly from the third position to the second position, wherein the apertures are aligned with their respective tips when the wash apparatus is in the third position,

the wash apparatus having at least one of an ingress and egress for wash fluid.

28. The pipetter of claim 27, wherein at least one of the apertures is arranged for receiving the tip of a pipette comprising a thin-walled cylindrical chamber with a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

Nanopipette Carrier

29. A pipette carrier for use in an automated workstation, comprising

a pipette having a proximal end and a distal end,

a plunger disposed for motion relative to the pipette,

a first element for at least pushing the plunger toward a distal end of the pipette,

a second element having an aperture in which the plunger is slidably disposed, the aperture being disposed between the first element and the proximal end of the pipette, the aperture being sized to prevent buckling of the plunger when the latter is pushed by the first element.

30. The pipette carrier of claim 29, wherein at least the proximal end of the pipette is disposed within a ferrule that is seated within a third element.

31. The pipette carrier of claim 30, wherein the proximal end of the pipette is disposed within a plenum within the third element.

32. The pipette carrier of claim 31, wherein the third element comprises at least one of an inlet and an outlet for wash fluid.

33. The pipette carrier of claim 29, wherein the aperture is disposed along a desired path of motion of the plunger.

34. The pipette carrier of claim 29, wherein the aperture is sized to permit motion of the plunger without such play as permits buckling of plunger or adversely impact positioning of its distal end.

35. The pipette carrier of claim 29, wherein the pipette comprises a thin-walled cylindrical chamber comprising a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

36. In a pipette carrier of the type for carrying a plurality of pipettes, the improvement comprising

one or more pipettes coupled to a first member,

one or more plungers coupled to a second member,

the first and second members being coupled for motion relative to one another,

a third member disposed between the first and second members for motion relative to at least one of them,

the third member having one or more apertures in each of which one or more plungers are slidably disposed, at least one of the apertures being sized to reduce buckling of the one or more plungers disposed therein when those plungers are pushed.

37. In the pipette carrier of claim 36, the further improvement wherein at least one of plungers is sized to permit motion of the one or more plungers disposed therein without such play as permits buckling of those plungers or otherwise adversely impacts positioning of their distal ends when those plungers are pushed.

38. In the pipette carrier of claim 36, the further improvement wherein at least one of the pipettes is removably mounted to the first member.

39. In the pipette carrier of claim 38, the further improvement wherein at least one of the pipettes is disposed within a ferrule that is seated within the first member.

40. In the pipette carrier of claim 39, the further improvement wherein the proximal end is flanged of a pipette that is disposed within a ferrule.

41. In the pipette carrier claim 36, the further improvement wherein the pipettes are arranged in any of an array or matrix.

42. In the pipette carrier of claim 36, the further improvement wherein at least one of the plungers is removably mounted to the second member.

43. In the pipette carrier of claim 42, the further improvement wherein each plunger has a corresponding pipette, the proximal end into which the distal end of that plunger extends.

44. In the pipette carrier of claim 36, wherein the pipette comprises a thin-walled cylindrical chamber comprising a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

45. In a pipetter for use with a robotic arm, the improvement comprising

a first plate (hereinafter termed “lower” plate) from which a set of pipettes extend,

a plunger assembly that includes

a second plate (hereinafter termed “upper” plate),

a set of plungers mounted in the upper plate, each plunger corresponding to a pipette in the set of pipettes and extending from the upper plate to the corresponding pipette,

the plunger assembly being coupled to the first plate for reciprocating motion with respect thereto,

the plunger assembly further including one or more anti-buckle plates disposed between the upper and lower plates, the one or more anti-buckle plates including apertures through which the plungers are slidably disposed, the apertures being sized to substantially prevent buckling of the plungers.

46. In the pipetter of claim 45, wherein the first plate includes a plenum in which proximal ends of the pipettes are in fluid communication.

47. In the pipetter of claim 46, comprising one or more fluid lines to any of supply wash fluid to and remove wash fluid from the plenum.

48. A pipetter, comprising

a pipette having a proximal end and a distal end,

a plunger disposed for motion relative to the pipette,

a first element for at least pushing the plunger toward a distal end of the pipette,

a second element having an aperture in which the plunger is slidably disposed, the aperture being disposed between the first element and the proximal end of the pipette, the aperture being sized to reduce buckling of the plunger when the latter is pushed by the first element,

an effector comprising a motor that is coupled to at least one of the first and second elements for moving at least one of the plunger and the pipette relative to the other.

49. A pipetter, comprising

a pipette having a proximal end and a distal end,

a plunger disposed for motion relative to the pipette,

an aperture in which the plunger is slidably disposed, the aperture being sized to reduce buckling of the plunger when the latter pushed relative to the pipette.

50. A pipetter of claim 49, comprising a motor for moving the plunger and the pipette relative to the other.

51. A pipetter of claim 50, comprising a suction member providing coupling between the motor and at least one of the plunger and the pipette.

52. A pipetter of claim 51, wherein the suction member is a suction cup.

53. A pipette carrier of claim 52, wherein the pipette comprises a thin-walled cylindrical chamber comprising a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

54. A pipetter for use with a robotic arm, the pipetter comprising

a nanopipette carrier including

one or more nanopipettes coupled to a first plate-like member, at least one nanopipette comprising a thin-walled cylindrical chamber having a body with a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters,

one or more plungers coupled to a second plate-like member,

a third plate-like member disposed between the first and second members for motion relative to at least one of them,

the third plate-like member having one or more apertures in each of which one or more plungers are slidably disposed, at least one of the apertures being sized to reduce buckling of the one or more plungers disposed therein when those plungers are pushed,

an effector that is coupled to the carrier by way of at least a suction member, the effector for at least pushing the plungers relative to the nanopipettes.

55. The pipetter of claim 54, wherein the suction member comprises a suction cup arranged for releasable coupling to the second plate-like member.

56. The pipetter of claim 54, wherein the effector is coupled to the robotic arm.

57. The pipetter of claim 54, wherein the effector comprises a motor that is coupled with any of the first and second plate-like members.

58. The pipetter of claim 57, wherein the motor is arranged for at least one of pushing and pulling the plungers relative to the nanopipettes.

59. The pipetter of claim 58, wherein the nanopipette carrier is releasably coupled to the effector.

60. The pipetter of claim 58 comprising a fourth plate-like member that is coupled to the carrier, the fourth plate-like member providing a magnetic field for one or more of the nanopipettes.

61. The pipetter of claim 60, wherein the fourth plate-like member comprises one or more apertures arranged to receive distal tips of each of one or more nanopipettes, each aperture having an associated magnetic field source.

62. The pipetter of claim 60, wherein the fourth plate-like member is releasably attached to the carrier.

Processing/Thermal Cycling Station

63. A processing station for use with a pipetter effector, comprising

a housing defining a cavity arranged to receive a set of nanopipettes carried by the pipetter effector,

the housing having a surface that at least one of supports and couples with effector,

the cavity having a surface including a sealing member arranged for sealing distal tips of nanopipettes received in the cavity.

64. The processing station of claim 63, wherein the cavity is sized to receive the set of nanopipettes at multiple registration positions.

65. The processing station of claim 64, wherein the housing surface includes at least one of a hole and a pin defining at least one said registration position.

66. The processing station of claim 65, wherein the at least one hole and pin is arranged to mate with structure on the pipetter effector.

67. The processing station of claim 63, wherein the first surface comprises an environmental sealing member that mates with the effector.

68. A processing station for use with a pipetter effector, comprising

a housing defining a cavity arranged to receive a set of nanopipettes carried by the pipetter effector,

the cavity having a wash member with one or more apertures arranged for receiving nanopipettes in the cavity, and

the wash member having a medium for washing one or more nanopipettes received by the wash member.

69. The processing station of claim 68, wherein the wash member comprises a reservoir for the medium.

70. The processing station of claim 68, wherein the wash member comprises a plurality of apertures, each for receiving a respective one of the nanopipettes.

71. The processing station of claim 68, wherein the wash member comprises at least one of an inlet and an outlet for the wash medium.

72. In a thermal processing station for use with a pipetter effector, the improvement comprising

a cavity arranged to receive one or more pipettes,

an airflow path that includes at least a portion of the cavity in which the pipettes are received,

the cavity being arranged with respect to the airflow path such that pipettes received in the cavity are exposed to an equi-temperature airflow.

73. In the thermal processing station of claim 72, the further improvement comprising a heater and a fan disposed, the heater and fan being arranged for generating a heated airflow along the airflow path.

74. In the thermal processing station of claim 73, the further improvement wherein the heater is positioned so as not to directly heat the pipettes by radiance.

75. In the thermal processing station of claim 74, the further improvement comprising baffles disposed between the heater and the pipettes.

76. In the thermal processing station of claim 73, the further improvement wherein the fan is a paddle wheel-style fan.

77. In the thermal processing station of claim 73, the further improvement comprising a baffle that can be set in one or more positions to permit at least one of environmental and cooling air to be drawn into the airflow path.

78. In the thermal processing station of claim 77, the further improvement wherein the baffle can be set in a position to permit recirculation of air.

79. In the thermal processing station of claim 73, the further improvement comprising a temperature-sensing device arranged for measuring a temperature of the airflow.

80. In the thermal processing station of claim 79, the further improvement wherein the temperature-sensing device is arranged for measuring a temperature of the airflow in a vicinity of the pipettes.

81. In the thermal processing station of claim 72, the further improvement wherein one or more of the pipettes comprise a thin-walled cylindrical chamber having a body with a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

82. A thermal processing station for use with a pipetter effector, comprising

a housing defining a cavity arranged to receive a set of nanopipettes carried by the pipetter effector,

an airflow path that includes at least a portion of the cavity in which the nanopipettes are received,

a heater for heating an airflow in the airflow path,

a baffle that selectively permits at least one of environmental and cooling air to be drawn into the airflow path,

a thermocouple arranged for measuring a temperature of the airflow,

the cavity being arranged with respect to the airflow path such that pipettes received in the cavity are exposed to an equi-temperature airflow.

These and other aspects of the invention are evident in the drawings and in the description that follows.

### BRIEF DESCRIPTION OF THE DRAWINGS

A further understanding of the invention may be attained by reference to the drawings, in which

FIGS. 1-4 depict the overall structure and operation of a continuous processing automated workstation according to the invention;

FIG. 5 depicts a single-belt drive mechanism according to the invention for positioning a robotic arm along the x- and y-axes;

FIGS. 6A-6F depict how the drive mechanism of FIG. 5 effects motion of x- and y-axis robotic arm carriages in a continuous processing automated workstation according to the invention;

FIGS. 7A-7F and 8A-8G depict a robotic arm and a “basic” effector according to the invention, as well as their use in inventorying specimen plates and plate handling;

FIGS. 9A-9C depict a robotic arm and a pipette-type effector according to the invention, as well as their use in processing specimen plates;

FIGS. 10A-10G depict a pipette-type effector with an on-board tip wash/plate rinse mechanism according to the invention;

FIGS. 11A-11B and 12A-12B depict a pipette-type effector with a fluid fill level detection mechanism according to the invention;

FIGS. 13A-13C depict a pipette-type effector with a back-flush mechanism according to the invention;

FIG. 14 depicts a thin-walled pipette comprising a glass tube, a plunger and a stainless steel tip for use in processing specimens according to the invention;

FIG. 15 depicts the sequential processing steps for purifying samples within a thin-walled pipetter according to the invention;

FIGS. 16A-16C depict an effector with a release mechanism according to the invention;

FIGS. 17A-17B depict a nanopipette carrier according to the invention;

FIGS. 17C-17D depict an adapter for and its use with the nanopipette carrier of FIGS. 17A-17B according to the invention;

FIGS. 18A-18C depict an effector for use with the carrier of FIGS. 17A-17B according to the invention;

FIGS. 19A-19C depict a processing station for use with the nanopipette carrier and effector of FIGS. 17-18 according to the invention;

FIGS. 20A-20B depict the processing station of FIGS. 19A-19C adapted for washing and/or flushing nanopipettes according to the invention;

FIGS. 21A-21E depict a single (or multiple) pipetter effector equipped with pipette wash mechanism according to the invention;

FIG. 22 is a cross-section view of the processing station of FIGS. 19A-19C adapted for thermal cycling of nanopipettes according to the invention.

### DETAILED DESCRIPTION OF THE INVENTION

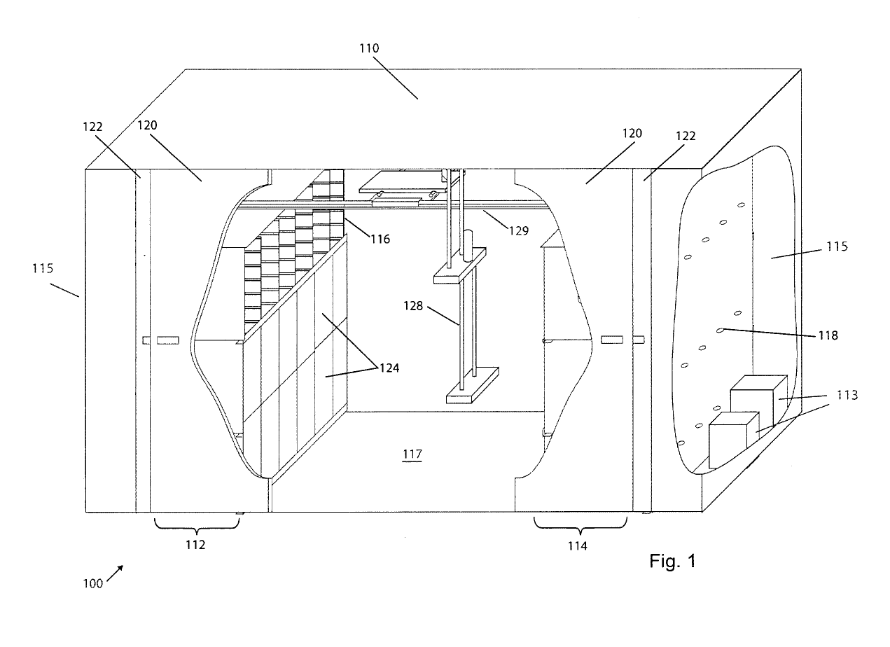

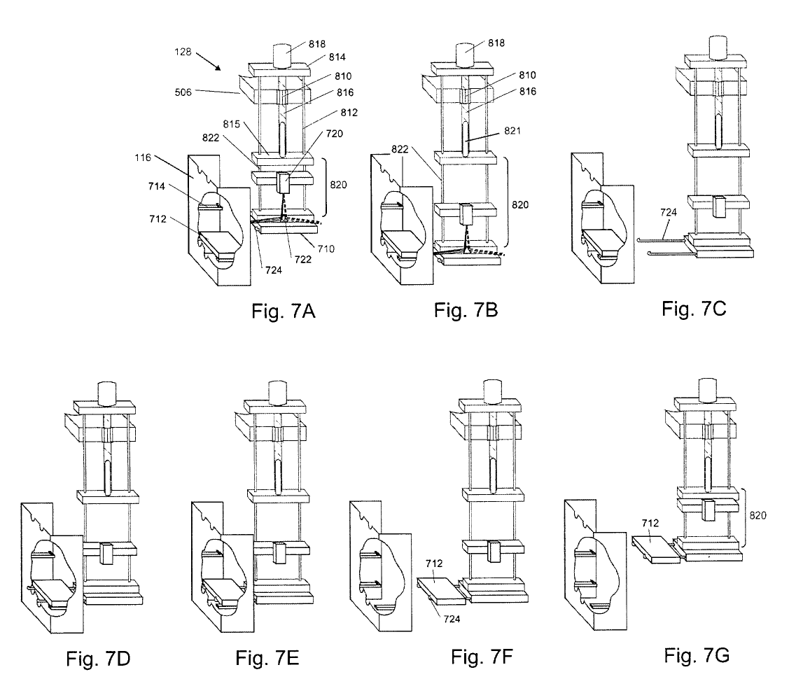

FIGS. 1-4 illustrate an automated laboratory workstation 100 according to the invention. The workstation includes a housing 110, which in the illustrated embodiment comprises environmentally controlled storage areas 112, 114 for cassettes 116 of specimen plates, e.g., standard 96-well or 384-well plates (see element 712 of FIG. 7A). Environmental control apparatus 113 in compartments 115 generates cooled, warmed, humidified, dehumidified or other environmentally controlled air (or other such gas or fluid) which is passed to the storage areas 112, 114 and work area 117, e.g. through vias or holes 118, as illustrated. The cassettes are preferably open sided, e.g., as shown in FIG. 3, or otherwise configured to permit that air to contact the plates and/or specimens.

The workstation has access panels 120 and 122 for covering and limiting operator access to the storage areas 112, 114 and work area 117, respectively. In the preferred embodiment shown in FIG. 1, the panels 120, 122 slide laterally to allow such access, though pivoting or other mechanisms for movement of the panels may be used instead. Inner panels 124, which likewise cover and limit access to plates within the storage areas, are automatically opened in connection with motion of the robotic arm 128. For ease of illustration, no panels 124 are shown for the top row of cassettes 116 in storage area 112. Though the illustrated workstation includes only two external panels 122 for the cassettes, those skilled in the art will appreciate that further such panels may be provided. Thus, for example, individual external and internal access panels may be provided for each respective cassette. Likewise, though the illustration shows one internal panel 124 per cassette zone (e.g., per six plates), an alternate embodiment can utilize fewer panels 124, e.g., two or three panels per side of the workstation.

In preferred embodiments, a electromechanical interlock (not shown) prevents the operator (e.g., scientist or laboratory technician) from opening the external panel 122 covering a given cassette if the internal panel 124 for that same cassette is open for the robotic arm 128 to access a plate of that cassette. The interlock, further, prevents the robotic arm control circuitry from opening the internal panel 124 covering the plate within a cassette when the external panel 122 for that cassette is open. Such an interlock facilitates use of the workstation for continuous processing, since cassettes can be introduced into (or removed from) the workstation through one panel 122, without interrupting processing of cassettes covered by the other panel 122. A further interlock (not shown) likewise prevents the operator from opening the external panel 122 if the robotic arm is in motion and, conversely, prevents the robotic arm from moving if the external panel 122 is open.

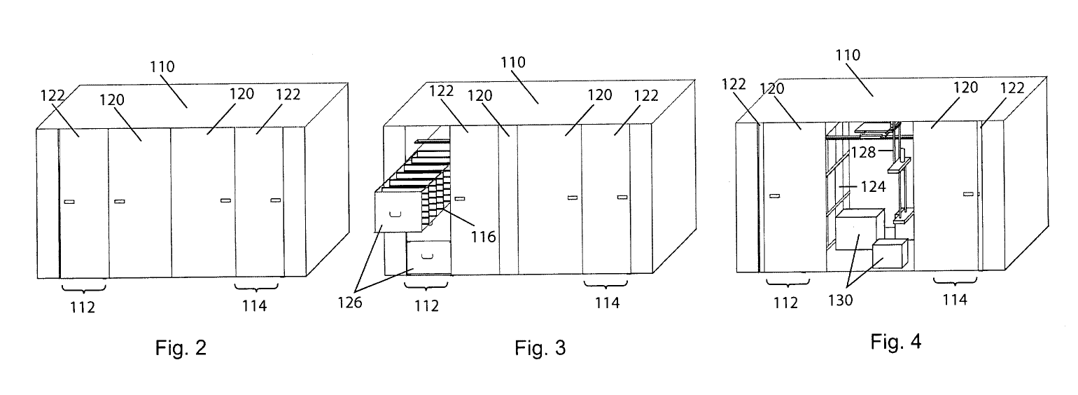

FIG. 2 shows the workstation of FIG. 1 with outer panels 120 and 122 closed. This is the typical condition of the panels during processing of specimens, though as discussed above, operation can continue even with a panel 122 open, though not with panel 120 open.

FIG. 3 illustrates the loading or unloading of a specimen cassette 116 via an external access panel 122. In a preferred embodiment, the specimen cassette 116 slides on fix guides (not shown) mounted on the inner side walls of each storage area 112, 114. Alternate mechanisms may also be utilized in place of such guides, e.g., telescoping rails. The aforementioned interlock can be configured to prevent a cassette 116 from sliding onto or off of these rails and, therefore, from being inserted into or removed from the storage area 112, when the robotic arm 128 is accessing a plate in the cassette 116.

FIG. 4 shows how the work area 114 of the workstation can be accessed through the center panels 120, e.g., for purposes of installing or removing transfer stations, filling or exchanging fluid reservoirs, laboratory equipment and further work pieces 130 for use in manipulating and processing specimens or specimen plates. Visible in that drawing, as well as FIG. 1, is a robot arm 128 for use in moving the plates to/from the cassettes 116 and the work pieces 130. The robot arm 128 is also used for performing processing of the plates, e.g., pipetting fluid into and out of the specimen wells.

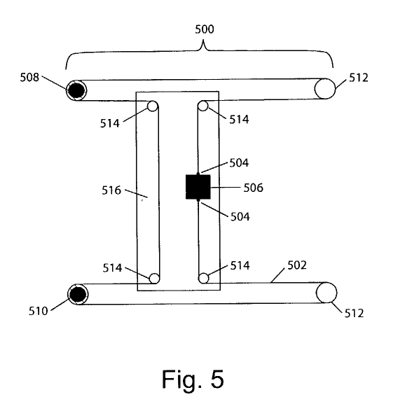

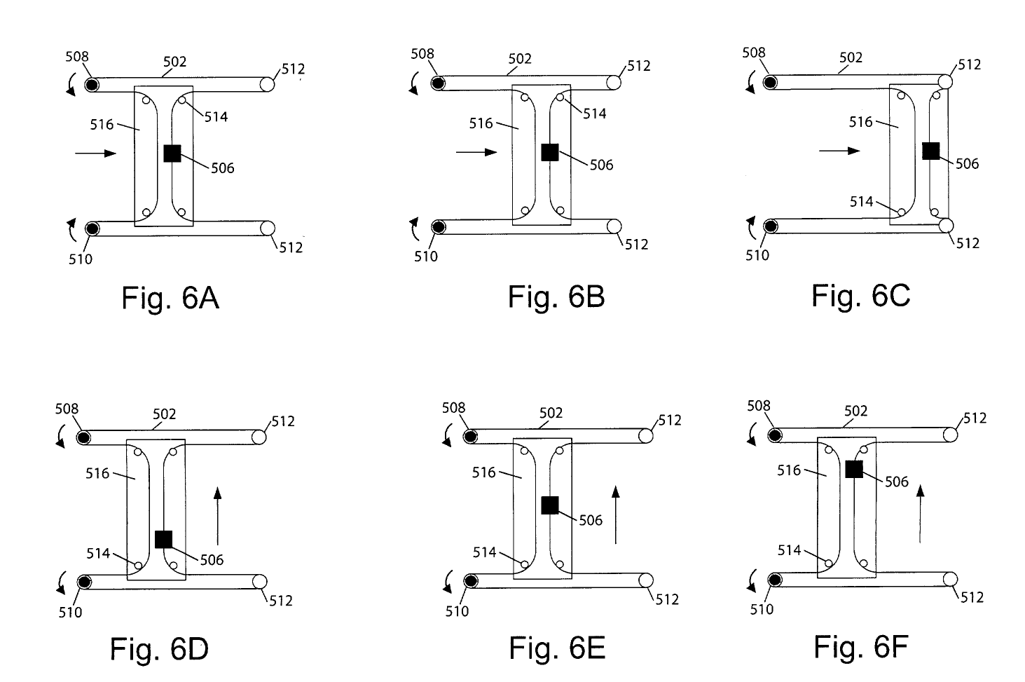

With reference to FIG. 1, robotic arm 128 is disposed on a track 129 above the work area 117 and storage areas 112, 114. A belt drive assembly 500, most clearly visible in FIGS. 5 and 6, is used to move the arm 128 in the x-y plane. The belt drive assembly 500 disposed on track 129 utilizes a single, integral belt 502 to position an x-axis carriage 516 and y-axis carriage 506 on which the arm 128 is mounted. Y-axis carriage 506 moves in the y-axis direction (vertically, as shown in the drawings) on the x-axis carriage 516, which itself moves in the x-axis direction (horizontally, as shown in the drawings) on the track 129.

In the illustrated embodiment, belt 502 is affixed on opposing sides of y-axis carriage 504, as illustrated, and is wound in an “H” configuration around drive wheels 508, 510 and idler wheels 512 and 514, as shown. The idler and drive wheels 508-512 are coupled to the track 129 or to the housing 110 of the workstation 100 and, thus, are stationary relative to the carriages 506, 516 and arm 128. Two of those wheels 512 may be mounted directly or held by springs or other such biasing mechanisms (not shown) so as to increase or adjust tension in the belt. Idler wheels 514 are mounted to the x-axis carriage 516, as shown, to complete the winding path of the belt 502. The system may optionally include wheels affixed to the frame along the path of the belt, e.g., adjacent wheels 512, which decrease the mechanism width and, thereby, permit the use of a larger x-axis carriage 516 for more travel of y-axis carriage 506.

Though the illustrated embodiment utilizes two drive wheels and six idler wheels, those skilled in the art will appreciate that other combinations of drive and idler wheels may be utilized to attain single-belt drive in the manner described herein. Moreover, it will be appreciated that the wheels may comprise gears, pulleys, posts or other structures about which the belt may be routed and/or by which it may be rotated.

The use of the assembly to move the carriages 506, 516 and, therefore, the robot arm in both x- and y-directions is illustrated in FIGS. 6A-6F. FIGS. 6A-6C show how motion in the “positive” x-direction is attained. Specifically, with drive wheel 508 rotated counterclockwise and drive wheel 510 rotated clockwise in an equal amount, as shown in FIG. 6A, the belt 502 is drawn against idler wheels 512, thereby moving the carriage 516, and the attached idler wheels 514 and robot arm 528 via y-axis carriage 506, to the right, as shown in FIGS. 6B and 6C. Clockwise rotation of drive wheel 508 combined with equal counterclockwise rotation of wheel 510, conversely effects motion of the carriage to the left (or “negative” x-direction).

FIGS. 6D-6F show how motion in the y-direction can be accomplished. If drive wheels 508 and 510 are both rotated counterclockwise, as shown in FIG. 6D, there will be no net force on the x-axis carriage 516 but rather, on the y-axis carriage 506. This will cause that carriage 506 to move upward or in the “positive” y-direction along the belt path, as shown in FIGS. 6E and 6F.

As will be apparent to those skilled in the art, combinations of x- and y-direction motion may be achieved by rotation at different rates of drive wheels 508 and 510. X-direction motion is always accomplished by motion of both carriages 506, 516 and attached arm 128, while y-direction motion is achieved by motion of carriage 506 and arm 128 relative to the carriage 516.

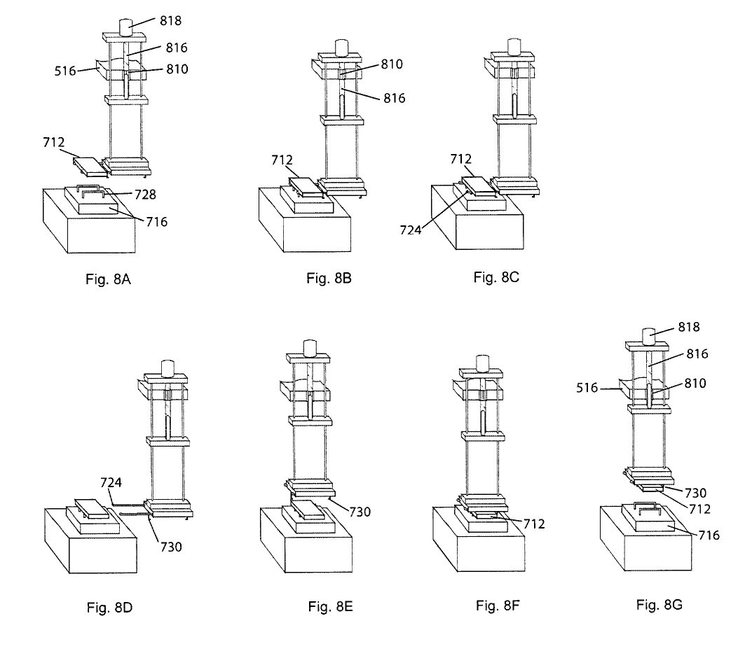

In addition to the x-y mobility afforded by the belt drive assembly 500, apparatus is also provided for extending the arm 128 in the z-direction, as shown in FIGS. 7 and 8 and described below. With reference to those illustrations, the arm 128 utilizes a combination of motor and pneumatic drives for positioning guide rails and support plates upon which plate handling (or “basic”) effectors and other types of end effectors are mounted.

The arm 128 includes a lead screw 816 that turns within a “nut” 810 or other threaded element affixed to the y-axis carriage 506. A frame, which is comprised of top stabilizer plate 814, bottom stabilizer plate 815, and guide rails 812, is coupled to the lead screw as illustrated. The lead screw 816 is rotated by servo motor 818 or other such device affixed to one of the stabilizer plates, here, top stabilizer plate 814. Rotation of the lead screw 816 within the nut 810 raises or lowers the frame (i.e., stabilizer plates 814, 815 and guide rails 812), as well as any assemblies thereon (e.g., basic end effector 710) relative to the y-axis carriage 506.

The arm 128 also includes a pneumatically extensible section 820 that can be used to further extend its range along the z-axis range. By mounting effectors, such as basic end effector 710, on section 820, their range of vertical motion can be extended without requiring a correspondingly long lead screw 816.

The extensible section 820 comprises a pneumatic piston 821 or other such apparatus that is mounted on bottom stabilizer plate 815 for extending telescoping or extending rods 822, seen most clearly in FIG. 7. FIGS. 7A and 7G show the rods 822 in a retracted (high) position, while FIGS. 7B-7F show the rods 822 in an extended (low) position. It is preferred that the lead 816 screw has a working length at least as long as the “throw” of the rod 822. This ensures that fine z-axis control is available through the lead screw 816 for the entire vertical range of the arm.

As discussed above, the robot arm 128 is movable in the x-, y- and z-directions. This versatile range of motion allows the arm 128 to be used for a variety of plate handling and plate processing steps. For example, a system and method for using the robot arm 128 to remove a specimen plate 712 from a cassette 116 and place it on work surface 716 is shown in FIGS. 7 and 8. Also shown are novel apparatus and methods for inventorying plates 712 in the cassette 116. Other functions can be achieved through the use of a variety of specialty effectors, e.g., pipetter arrays.

In order to use the arm 128 to inventory cassettes and plates, the assembly 710 is moved to a position adjacent to the cassette 116 and/or plates 712 so that identifying markings on the them can be “read” by sensor 720 which, in the illustrated embodiment, comprises a bar code reader or other such optical sensing device. A beam splitter 722 is preferably employed to provide optical sensing pathways in multiple directions, as illustrated. This permits the sensor 720 to “read” bar code tags or other indicia on disposed on either side of the assembly 710 without reorientation (e.g., rotating the assembly 710 or arm 120). Those tags can identify the respective cassettes or plates and, optionally, indicate their type and contents, which information can be used in subsequent plate handling, processing or reporting operations. To perform an inventorying function, the arm 128 and, particularly, the assembly 710 is repositioned from cassette to cassette and from plate to plate in order that information regarding them can be recorded.

Referring to FIGS. 7C and 7D, a basic end effector is attached to the pneumatically telescoping section of the arm 128 to permit grasping and moving plate 712 so that it may be moved to/from the cassette 116 and the storage areas 112, 114. For this purpose, the effector 710 includes telescoping arms or forks 724 that extend from the assembly 710 for positioning under the plate 712, as shown in FIGS. 7C and 7D, so that it can be lifted from (or deposited in) the cassette shelves. The forks 724 may include hooked ends or other structures for better grasping the plates by pinching them in a retracted state after they are picked up. Also, the ends of forks 724 are preferably tied together with a crossbar (not shown) to equalize their speeds of extension and retraction.

Once the forks 724 are under the plate, the arm 128 is raised slightly to lift the plate 712 clear of retaining flanges present on the cassette shelves, as shown in FIG. 7E. The forks then retract to grasp the plates. The arm 128 is then moved to clear the plate 712 from the cassette, as shown in FIG. 7F. Once free of the cassette 116, the plate can be moved over a work surface 716 (e.g., the surface of a transfer station or other work piece), as shown in FIG. 8A.

The work surface 716 is preferably be provided with supports 728 to accommodate the forks 724 and, thereby, to facilitate placement and removal of the plates, as shown in FIG. 8. The assembly 710 can then be lowered to the transfer station with the forks 724 between the supports 728, so that the plate 712 rests on and is registered in the supports 728, as shown in FIG. 8B. The forks 724 can then extended to free the hooked ends from the plate, as shown in FIG. 8C, and the assembly 710 can be moved down, then, horizontally to fully clear the plate, as shown in FIG. 8D. The foregoing operations may be reversed to pick up a plate from a work surface and insert it into a cassette 116.

Though illustrated basic end effector 710 has pickup forks 724 on only one side, preferred embodiments include such forks on both sides of the effector 710. This permits the arm 128 to handle plates in either storage area 112, 114, without reorientation (i.e., without rotating the effector 710 or the arm 128).

In addition to engaging plates from the side with forks 724, a preferred basic end effector 710 includes downwardly extending grippers 730 for engaging plates from the top and, thereby, facilitating their movement to/from top-loading processing apparatus. The grippers, which can include hooked ends as shown in the drawings, move inwardly (relative to a central region 729 of the effector) in order to pinch or grasp a plate, as well as outwardly in order to release a plate. Additionally, they can be extended downwardly via robot arm 128 to facilitate grasping or retracted for storage.

Use of the grippers is illustrated in FIGS. 8E-8G. In the illustration, the assembly 710 is maneuvered over the plate and lowered to a position slightly above it, as shown in FIG. 8E. The assembly 710 is lowered further and/or the grippers 730 are brought together in order to grasp the plate, as shown in FIG. 8F. Once the plate is captured, the assembly is raised in order to lift the plate, as shown in FIG. 8G. The arm 128 can then be moved to transfer the plate to a different location, for example one not accessible using the fork 724 subassembly described above.

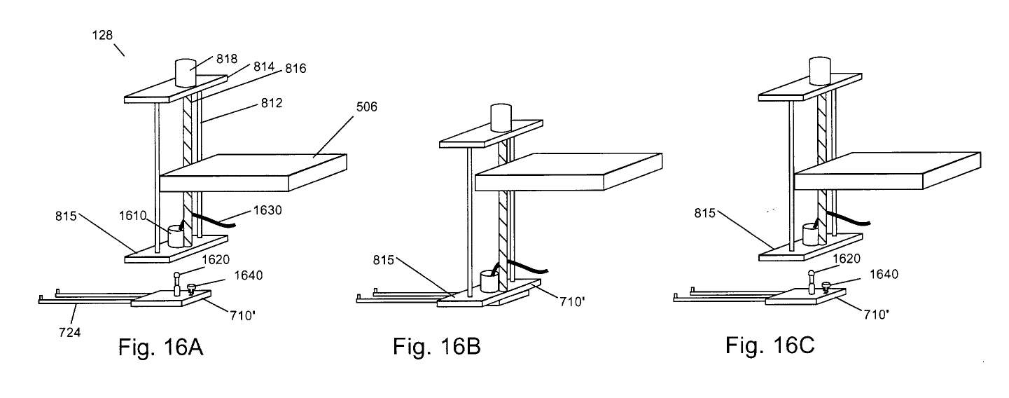

FIG. 16A illustrates an embodiment in which a basic end effector 710′, like effector 710 discussed above (albeit with fixedly extending forks 724), is coupled to the bottom plate 815 of the arm 128. In this embodiment the pneumatically extensible section (element 820 of FIG. 7A, et seq., but not shown here) is removed, retracted or put to other purpose. Coupling between the effector 710′ is effected via a pneumatic latch 1610 (e.g., of the “quick-connect” variety) or other actuator (pneumatic, manual or otherwise), disposed on support 815 (or elsewhere on arm 128), which releasably retains collared rod 1620 (or other elongate male coupling member), disposed on effector 710′.

In operation, the arm 128 and, more particularly, the frame (i.e., stabilizer plates 814, 815 and guide rails 812) is moved to position over effector 710′ via action of the belt drive assembly 500 (see FIGS. 5-6 and the corresponding text). Lead screw 816 is rotated to lower the frame until rod 1620 is firmly seated within latch 1610, thus, affixing the effector to the bottom plate 815, as shown in FIG. 16B. The frame can be raised, via reverse action of the screw 816, and the arm moved, via action of the belt drive assembly, to move the effector 710′ for plate handling, plate processing and other functions.

Upon completion of those functions (or as otherwise desired), the effector 710′ is decoupled from the bottom plate 815 via action of the latch 1610. See, FIG. 7C. For example, upon positioning the effector 710′ over suitable surface or holder, the latch 1610 can be actuated for release by pneumatic line 1630 (which may be, for example, the same line as that which drives the pneumatic piston 821).

To facilitate disengaging the rod 1620 from the latch 1610, the effector 710′ includes a release 1640 that exerts a torque countering, at least partially, that exerted by the effector's fixedly extending forks 724 and any microtiter plate or other weight disposed thereon. In the illustrated embodiment, that release 1640 comprises a spring-loaded, stepped or shouldered rod that stands proud from the upper or other surface of the effector 710′ that mates with the bottom plate 815 when the rod 1620 is engaged in the latch 1610. The rod is disposed on the proximal end of the effector 710′ separate from the shaft and opposite the forks 724 vis-a-vis the rod 1620. The rod's spring is gauged so as to exert a force on the plate 815 to counter the torque exerted by the forks 724 (and any weight thereon) to align rod 1620 with latch 1610 sufficiently to facilitate disengaging the rod 1620 from the latch 1610.

It will be appreciated that the release 1640 may be disposed for this purpose elsewhere on the effector 710′ or, instead, on the mating surface of the bottom plate 815; that it may be configured other than as a rod; and, further, that it may utilize a mechanism other than a spring to exert the countering force. It will also be appreciated that the release may be used with other effectors that couple with plate 815, extensible section 820 (in embodiments that employ it) and/or, more generally, the arm 128. And, it may be used in connection with coupling mechanisms, other than the illustrated rod/latch combination, whose disengagement is facilitated by a countering force of the type exerted by the release 1640.

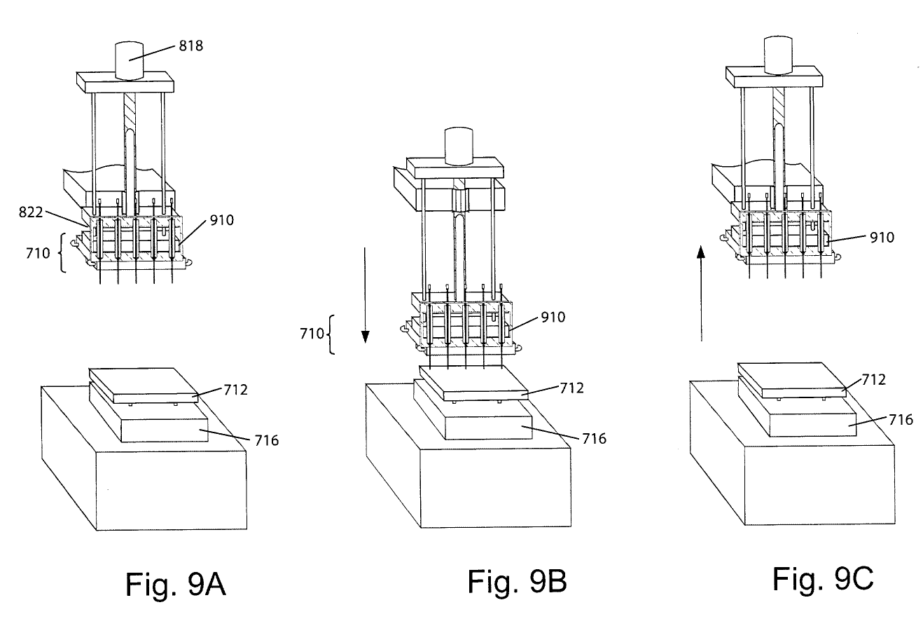

In addition to the basic end effector for plate handling, specialty effectors may be attached to the arm for use in performing a variety of processing tasks. FIG. 9 illustrates the action of such a specialty effector: a pipetter array. As shown, a set of parallel pipettes 910 is mounted on the screw-driven portion of the arm, e.g., on bottom support 815 or rods 812. With the pneumatically-extensible portion 822 in the retracted position, the effector 910 can be moved via rotation of the lead screw 816 so that its tips are in position to inject fluids into or remove fluids from the specimen plate 712.

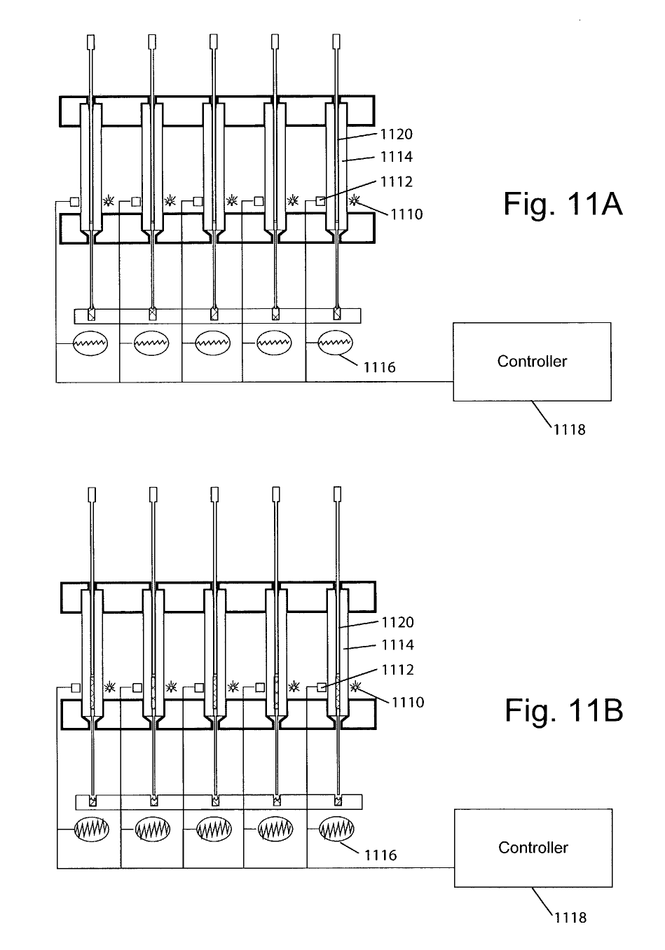

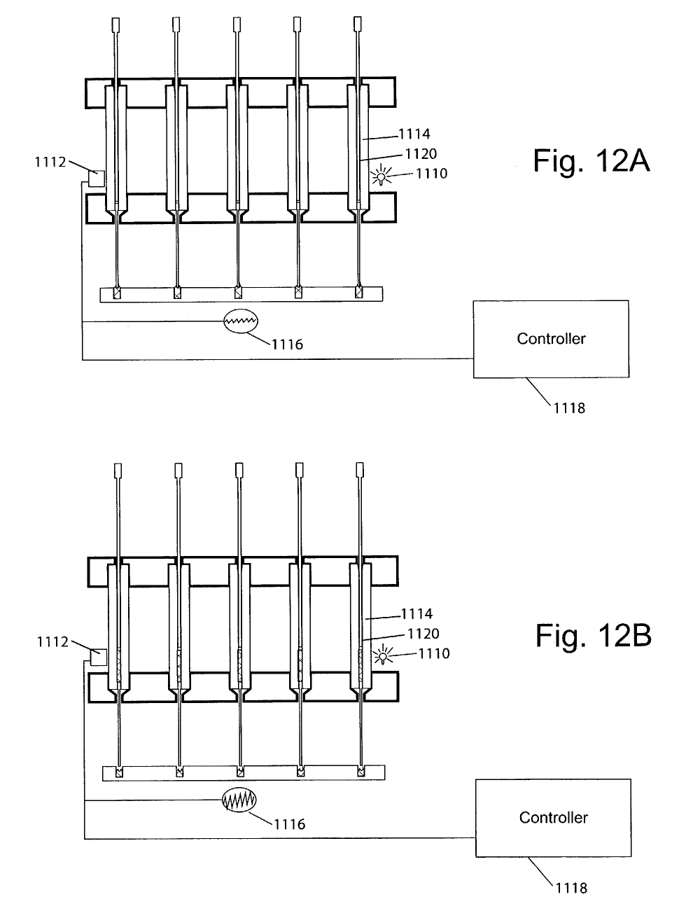

A system for determining fill levels in one or more pipettes may be included with such an array, as shown in FIGS. 11 and 12. With reference to FIG. 11, an LED 1110 (or other light source) and a photodetector 1112 is associated with each pipette. The LED 1110 and the photodetector 1112 are arranged so that light from the LED must pass through a pipette 1114 to reach the photodetector. The photodetector signal 1116 can then be monitored to determine whether the fluid level in the pipette is above or below the level of the LED 1110 and photodetector 1112. If the fluid level in the pipette is low, as shown in FIG. 11A, the signal 1116 produced by the photodetector 1110 will be small in amplitude due to refraction, as further described below. If the fluid level in the pipette is high, on the other hand, the signal 1116 will have a greater amplitude, as illustrated in FIG. 11B. This signal information is passed to a controller 1118, which utilizes the information to verify filling of the pipettes and, optionally, of the characteristics of the fill fluid.

FIG. 12 illustrates a related embodiment, in which a single LED/photodetector pair is used to monitor the fluid level in multiple pipettes. In this embodiment, light source 1110 and photodetector 1112 are disposed so that light from the source must pass through multiple pipettes 1114 to reach the photodetector. The photodetector signal 1116 will thus have a reduced amplitude due to refraction if any of the pipettes has a low fluid level, as shown in FIG. 12A. If all pipettes are filled above the level of the LED/photodetector pair, the amplitude of the signal 1116 will be increased, as shown in FIG. 12B.

The change in signal with fill level in both systems depends on the difference in the refractive index of air and of the fill fluid. The pipettes 1114 comprise a narrow channel 1120 through a thick body, as can be seen from the figures. The low curvature of the outside surface does not bend light entering the pipette from the LED 1110 significantly. When the light reaches the inside channel, however, it encounters a surface at a relatively oblique angle to the light path, due to the small radius of curvature of the channel 1118. If the material in the channel has a refractive index which differs significantly from that of glass, the path of the light will be bent and little light will reach the photodetector 1112. If the material in the channel has a refractive index similar to that of glass, the path of the light will not bend significantly, and much more light will reach the photodetector 1112. In preferred embodiments, an opaque nonreflective channel (not shown) may be provided between the pipette 1114 and the photodetector 1112, to absorb “bent” light and reduce the effects of reflections and scattered ambient light, thereby increasing the sensitivity of the system.

The response to the system may differ from that described above, for example when an opaque fluid is used. The system may be effectively used in such situations as long as the signal 1116 differs for a full and an empty tube 1114.

Calibration of this system thus depends in part on the refractive index of the fill fluid. In preferred embodiments, it is possible to adjust a set point threshold of the photodetector to adjust to differing fluid refractive indices. For example, a library of threshold set points may be provided so that the processing of the signal can be adjusted depending on the fluid used.

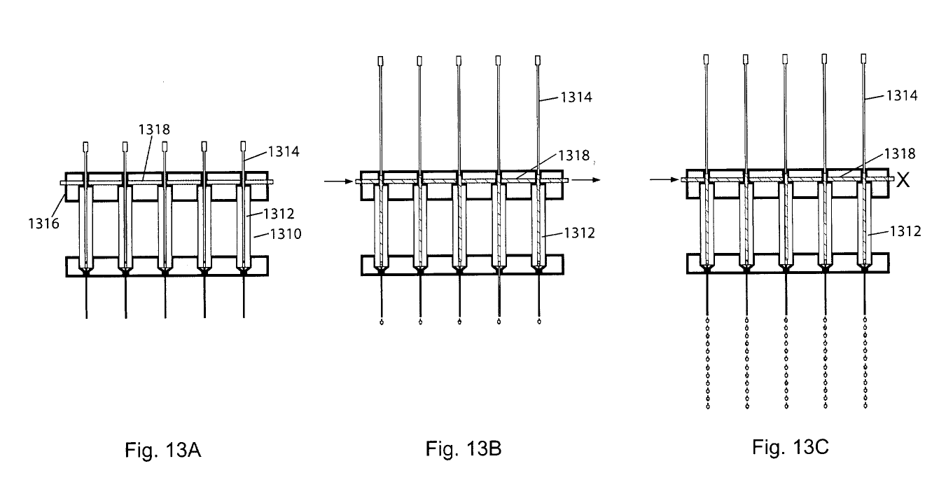

FIG. 13 illustrates a system for flushing one or more pipettes 1310, such as the array shown in FIG. 9. Each pipette comprises a body 1312 having a channel therethrough, and a plunger 1314 disposed in the channel for aspiration or expulsion of fluid through the pipette tip. The pipettes are mounted in a rack 1316 having a passage 1318 therein, which can be filled with distilled water or another cleaning fluid. When the pipettes are being used, the plungers 1314 extend into the pipette bodies 1312, blocking the water passage 1318, as shown in FIG. 13A.

When it is desired to clean the pipettes, for example to aspirate a different fluid, the plungers 1314 are withdrawn from the pipette bodies 1312. Water or other flush fluid can then flow through the passage 1318, as well as through the pipette channels, as shown in FIG. 13B. The flow of water through the pipette channels will generally be somewhat slow, due to the narrowness of the channels. If it is desired to flow more water through the pipettes, the outlet of the passage 1318 can be closed by a valve as shown in FIG. 13C. This blockage substantially increases the flow rate through the channels. The plungers 1314 can be reinserted into the pipette bodies to stop the flow of water and to eject any remaining water from the pipettes. In addition to facilitating flushing of the pipettes the illustrated arrangement helps to keep the pipettes in working fluid.

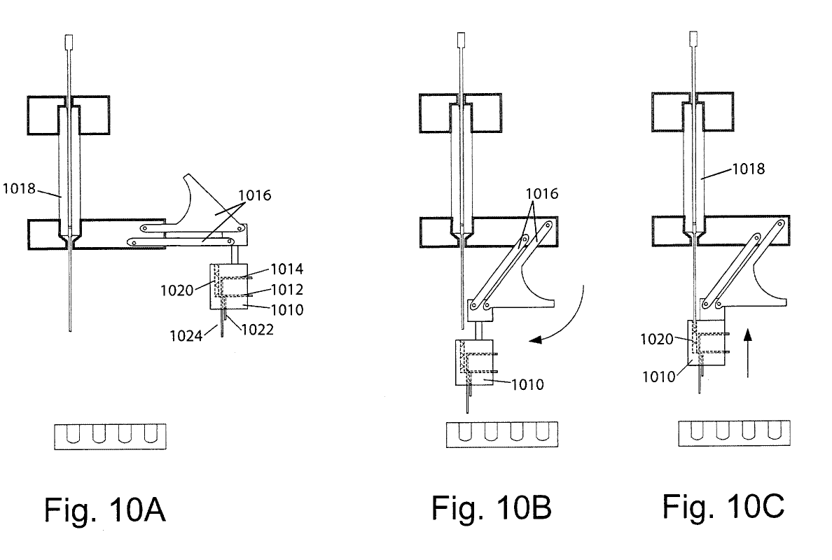

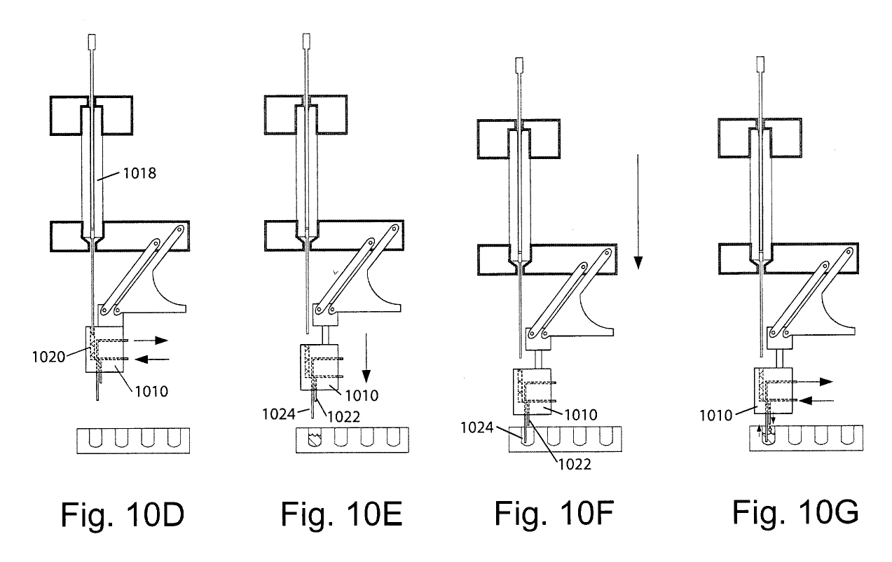

FIG. 10 illustrates a single pipette effector equipped with apparatus for cleaning pipettes and/or microtiter plates. The effector comprises a washing element 1010, which includes a reservoir 1020 (which catches fluid from the pipette) and an outlet 1014 for fluid lines, which carry distilled water or other cleaning fluid. The outlet 1014 may be connected to a vacuum pump (not shown).

When pipetting or plate handling functions are being performed, the washing element 1010 will generally be located in its default or carrying position, shown in FIG. 10A. When it is desired to clean a pipette or plate, the washing element 1010 can be rotated swung into working position by action of connectors 1016, as shown in FIG. 10B. The washing element 1010 may then be moved to bring reservoir 1020 into contact with the pipette tip, as shown in FIG. 10C. Alternatively, the pipette 1018 can be moved to place the tip in the reservoir 1020 position while the washing element 1010 remains stationary.

Pipette flushing fluids (which are preferably introduced into pipette 1018 through channels and passages of the type shown in FIG. 13 and discussed below) exit from the pipette 1018 into reservoir 1020 for purposes of flushing the tip of the pipette. Those fluids are drawn from the reservoir via outlet 1014 as shown by arrows in FIG. 10D. The washing element is then returned to its working position, as shown in FIG. 10E. Multiple reservoirs 1020 may be provided when the cleaning effector is used with a pipette array, as shown in FIG. 9.

The washing element 1010 further comprises an irrigator 1022 and an extractor 1024 for cleaning the microtiter plate. In use, as shown in FIGS. 10E-G, the extractor is brought into contact with a well of the microtiter plate by movement of the entire assembly, and water flows from the inlet 1012 to the irrigator 1022, where it is dripped or sprayed into the well. The extractor 1024 may then be used to remove the water via the outlet 1014. In this function, the washing element 1010 may be moved independently of the pipette assembly, if desired.

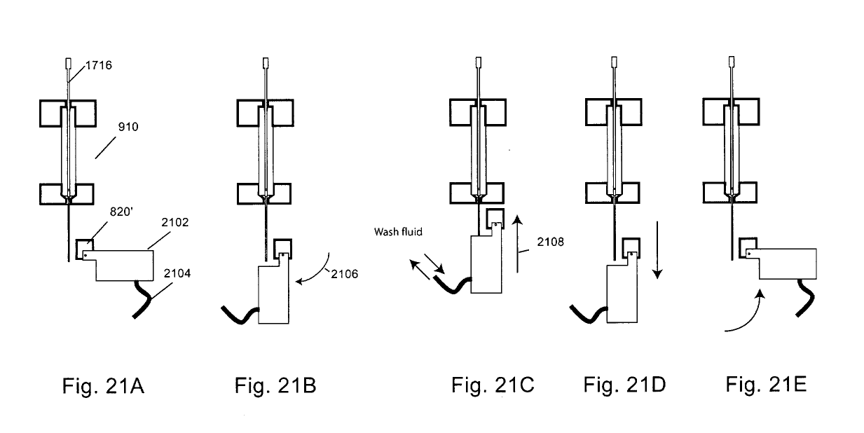

FIG. 21A is a side view of a single (or multiple) pipetter effector 910 equipped with pipette wash 2102 according to an alternate embodiment of the invention. As above, the effector 910 is mounted on the screw-driven portion of the arm, e.g., on bottom support 815 or rods 812. The wash apparatus 2102, on the other hand, is mounted on the pneumatically-extensible portion—here, designated 820′ to represent a plate or other mounting point on that portion 820. Alternatively, the wash apparatus 2102 can be mounted on an actuator 823 (e.g., itself disposed on the bottom support 815, rods 812 or other portion of the arm, effector or apparatus) that moves up and down relative to the tip(s) of pipette(s) in the manner shown in FIGS. 21B and 21C.

The wash element 2102 includes aperature(s) (not shown) arranged to receive distal tips of pipette(s) when the wash element 1702 is deployed. See, FIG. 21C. The apertures can be sized to permit slidable reciprocation of the tips with sufficient depth to facilitate (i) wash fluid to be drawn or forced into the respective nanopipettes via their tips, and/or (ii) wash fluid to rinse the tips themselves, e.g., to remove contaminants. The wash fluid can be contained in reservoir (not shown) disposed within the element 2102 and/or in individual fluid supplies associated with each aperture. A single line 2104 is shown here representing both an inlet and outlet for wash fluid supplied to the aforementioned reservoir and/or aperature(s).

When it is desired to wash the pipette(s), the wash apparatus 2102 is rotated from its carrying position as illustrated in FIG. 21A (wherein it is disposed clear of the pipette tips, e.g., so that they may be used, for example, to acquire, process and/or expel samples) to an intermediate position (as indicated by arrow 2106 and as shown in FIG. 21B) via action of the pneumatic element or other actuator. It is then translated linearly as indicated by arrow 2108 and shown in FIG. 21C, and brought into its operative position in contact with the pipette(s) tip(s) via action of the pneumatic element or other actuator.

Once in the operation position, distilled water or other flush fluid can be introduced and removed via line(s) 2104 in order to rinse the distal tips of the pipette(s). See, FIG. 21C. That fluid, too, can be used to flush the pipette(s), e.g., by retracting the plungers 1716 to draw the fluid into the pipette(s) and extending the plunger(s) to expel the fluid. In an effector configured, e.g., as shown in FIGS. 13A-13C and discussed below, the plunger(s) can be fully detracted (e.g., as shown in FIG. 13B) such that fluid introduced via line 2104 travels up the pipette(s) and out an effluent path.

Once the pipette(s) has (have) been washed, the apparatus 21C can be removed from deployment by reversal of the steps foregoing steps, as particularly illustrated in FIGS. 21D-21E.

Prior art in vitro processing of biological and chemical samples, e.g., for purposes of screening small molecules or sequencing nucleic acids, has generally required relatively large sample sizes. In conventional automated workstations, such samples are mixed and processed in wells of microtiter plates. The smallest sample size heretofore conventionally processed is approximately two microliters, a volume at which precision is only about 20% due to evaporation and other effects.

Embodiments of an automated workstation according to the invention permit the processing of still smaller samples with still greater precision. This entails aspirating or otherwise introducing the samples into narrow, thin-walled pipetters and—rather than transferring them to microtiter plate wells or other reaction vessels—performing processing on the samples while they are within the pipetters. By using such “nanopipetters” or “thin-walled pipetters” (as they are alternatively referred to herein) as both means for acquiring and processing the samples, such embodiments prevent sample loss during transfer (e.g., as a result of surface tension-related effects), during processing (e.g., as a result of evaporation), or otherwise. These embodiments, accordingly, permit sample sizes smaller than 2 microliters to be processed with high accuracy.

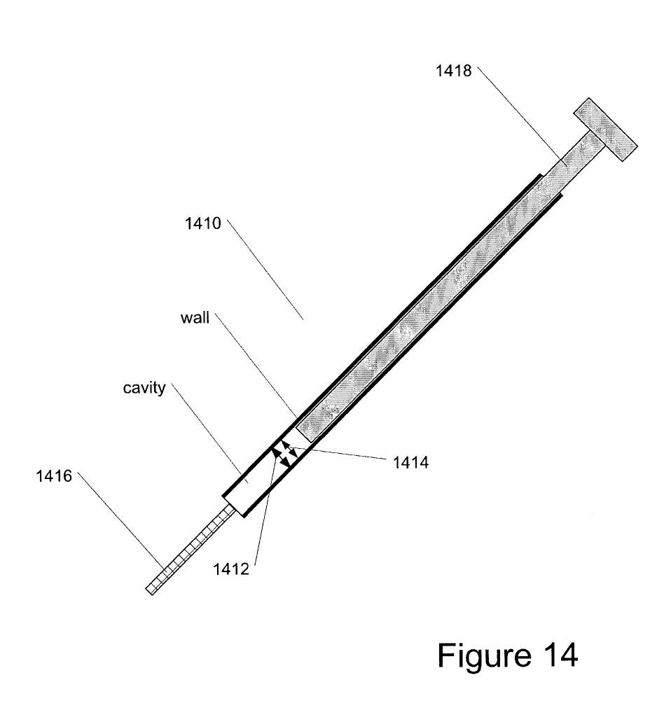

FIG. 14 depicts a nanopipette according to one practice of the invention. The illustrated device is a 90 mm long glass capillary chamber 1410 having a 1000 micron outer diameter 1412 and a 500 micron inner diameter 1414. A tip 1416, comprising a stainless steel hypodermic tube 25 mm long with an outer diameter of 500 microns and an inner diameter of 250 microns, may be optionally fitted at one end. The illustrated nanopipetter may be used for sample sizes from 50 nanoliters to several microliters.

Both larger and smaller sample sizes may be processed by nanopipetters of other dimensions. Thus, for example, the invention contemplates capillary-like chambers with wall thicknesses substantially equal to or under 1000 microns, 750 microns, 500 microns, or 250 microns, with the choice of thickness depending upon the availability of materials and suitability for intended use. Likewise, the chambers can have inner wall diameters (i.e., reaction cavity outer diameters) substantially equal to or under 1000 microns, 750 microns, 500 microns, or 250 microns. Once again, the choice depends on availability and suitability. Any combination of these aforementioned wall thicknesses and inner wall diameters may be employed.

Such nanopipetters may be of lengths suitable for the sample volumes to be processed and the workstation processing equipment with which they are used. Nanopipetters according to the invention can be used to process samples substantially equal to or under 10 microliters, 1 microliter, 100 nanoliters, 50 nanoliters, and/or under 10 nanoliters.

The illustrated nanopipetters are preferably used with tips, e.g., of the type described above or equivalents, though, they may be used without tips. Preferred nanopipetters are of circular cross-section, though, other cross-sections may be used instead. The pipetters may be constructed from glass, as indicated above, or from any other suitable substance or compound. Likewise, the tips and plungers may be constructed from stainless steel, other metals, ceramics, plastics, or other suitable substances.

Biological, chemical and other samples are introduced and dispensed from the nanopipetter of FIG. 14 via a plunger 1418 that, when drawn back, causes samples to be aspirated into the cavity or, when pushed forward, causes them to be dispensed from the cavity. Other techniques known in the pipetting art may be used instead to introduce or dispense samples from the pipetter. These include application of negative (vacuum) and positive pressures, capillary action, and so forth.

Regardless of their sizes and configurations, a set of such nanopipettes may be “ganged” together. Indeed, in one embodiment of the invention, an automated workstation of the type discussed above utilizes 96 nanopipettes configured and operated in the manner of the pipetter-type end effectors shown in FIGS. 9-13 (e.g., including tip washing mechanisms, backflushing mechanisms and fluid level detection mechanisms) and also described above. Nanopipettes according to the invention can also be used individually in other automated apparatus and configurations, as well as in non-automated applications.

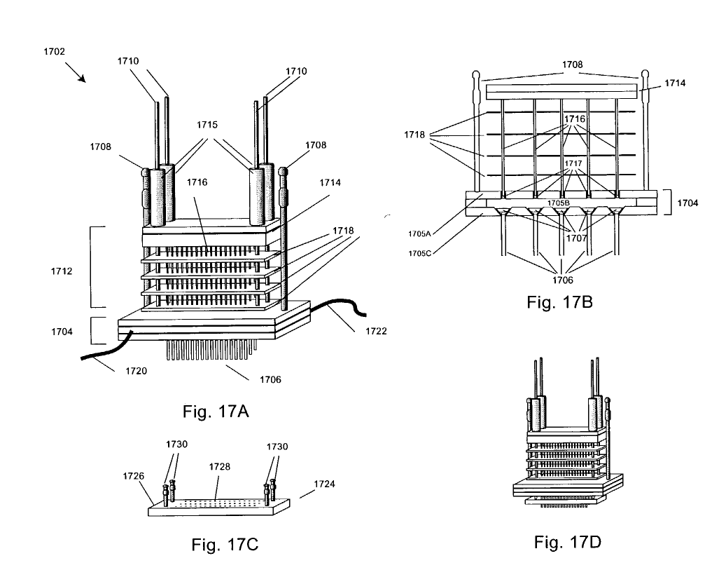

In an alternate embodiment, an automated workstation according to the invention utilizes a carrier 1702 of the type illustrated in FIGS. 17A-17B, in perspective and cross-section views, respectively, to transport and/or process specimens in sets of nanopipetters. The carrier includes a lower plate assembly 1704 comprising a plenum 1705B formed between upper and lower plates 1705A, 1705C. A set of nanopipettes 1706 sized as above are fixedly or, preferably, removably mounted in that assembly 1704, e.g., in an array or matrix configuration. In one embodiment, the set 1706 includes ninety-six nanopipettes arranged in a 4×24 matrix, though other counts and arrangements can be employed.

FIG. 17A shows the bodies and distal tips of the nanopipettes extend from the lower face of the assembly 1704. In the illustrated embodiment, their proximal ends are disposed within ferrules 1707 seated within corresponding mounting recesses in the lower plate 1705C, as shown. Illustrated ferrules 1707 are conical, as are the corresponding mounting recesses, though those skilled in the art will appreciate that other geometries may be used instead. The ferrules 1707 are typically stainless steel, though they can be fabricated from any other metals or from polymers, ceramics, composites and so forth. To facilitate fitting the nanopipettes 1706 in the corresponding ferrules, their proximal ends are preferably flanged, as indicated by the short dashed lines graphically depicted within the ferrules.

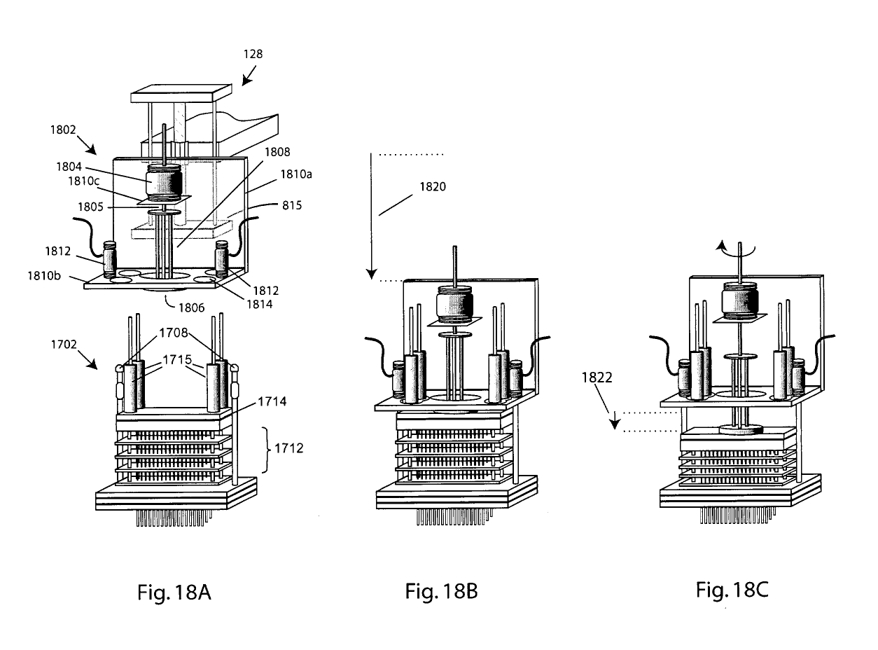

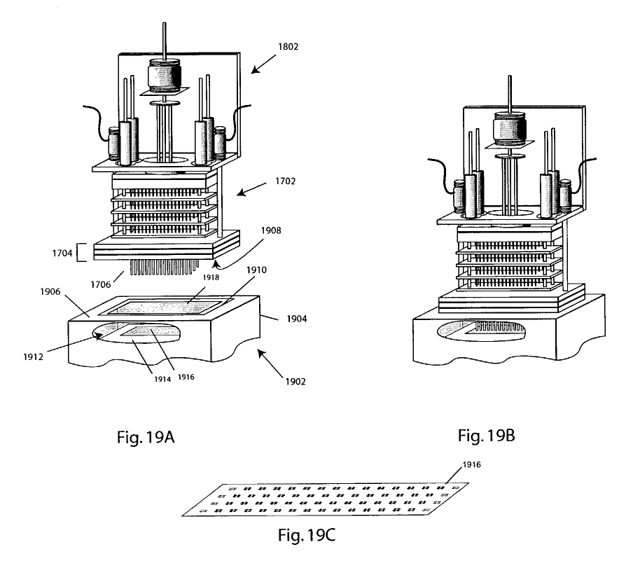

Firmly affixed to the assembly 1704 and extending from its upper face are rods 1708, which may be stepped, shouldered or otherwise profiled, e.g., as illustrated, for mating with pneumatic or other latching mechanisms on the arm 128 (e.g., bottom plate 815 or extensible section 820) or, preferably, in an effector as shown in FIGS. 18A-18C and discussed below.

Also affixed to assembly 1704 and extending from its upper face are rods 1710, which serve as guides for reciprocating nanopipetter plunger assembly 1712. That assembly 1712 includes a upper plate 1714 with apertures (not shown) and bearing rods 1715 through which the rods 1710 are slidably disposed. A set of plungers 1716 are fixedly or, preferably, removably mounted on or within the assembly 1712, each corresponding to a nanopipette in the set 1706 and arranged in like configuration. The proximal ends of the plungers extend to or into respective mount points on or in the plate 1714, which can be formed in two parts (as shown) to facilitate inserting and/or removing the plungers. The distal ends of the plungers extend, via apertures in which they are slidably received by the lower plate assembly 1714, into plenum 1705B. There, they are positioned for plunging in (and out) of proximal ends of the corresponding nanopipettes—or otherwise for altering pressures and/or volumes within those corresponding nanopipettes.

The plungers are sized in cross-section so that at least their distal tips 1717, which may be coated with nylon, Teflon® or other non-reactive and/or friction-altering materials, fit within the proximal ends of the nanopipettes in the conventional manner of a pipette or nanopipette plunger. Their length is selected based on distance between the maximal (or resting) distance between the upper and lower plate assemblies 1714, 1704 and/or the desired extent (or “delta”) with which the tips plunge into the nanopipettes during operation of the carrier 1702 and, more particularly, the reciprocating nanopipetter plunger assembly 1712. The plungers are typically stainless steel, though they can be fabricated from any other metals or from polymers, ceramics, composites and so forth.

Antibuckle or support plates 1718 are disposed in the reciprocating section 1712 between the upper plate 1714 and the lower plate assembly 1704. These include apertures (not shown) through which the rods 1710 are slidably disposed. As with the upper plate 1714, these apertures are sized to permit the antibuckle plates to move relative to rods 1710 with sufficient tolerance for friction, yet, without such play as adversely impacts positioning of distal ends of plungers.

The plungers are slidably disposed in additional apertures provided in antibuckle plates 1718 positioned along the desired path of plunger motion during reciprocation—e.g., in line with the mounting points of their proximal ends on/in the upper plate 1714 and the apertures in which they are slidably received in the lower plate assembly 1704. As above, the antibuckle plate apertures are sized to permit motion of the plungers 1716 relative to the antibuckle plates (and with respect to the nanopipettes) with sufficient tolerance for friction, yet, without such play as permits buckling of the plungers or as adversely impacts positioning of their distal ends, e.g., in the nanopipettes.

Fluid lines 1720, 1722 supply and remove wash fluid to the plenum 1705B for rinsing the distal ends of the plungers 1716 and the proximal ends of the nanopipettes 1706, e.g., to remove decontaminates. The fluid can also be used to flush the nanopipettes themselves, e.g., in a manner similar to that shown with respect to the pipettes of FIGS. 13A-13C.

FIG. 18A depicts an effector 1802 for use, e.g., with carrier 1702, to facilitate transport and/or processing of specimens in sets of nanopipettes 1706. The effector 1802 can be coupled to robotic arm 128 via its bottom support plate 815, extensible section 820 or otherwise. Coupling may achieved using the rod/latch combination discussed above in connection with FIGS. 16A-16C, but not illustrated here, or otherwise.

The effector 1802 includes a stepper or servo motor 1804 with linear drive 1805 that is coupled to a suction plate 1806 via a rigid support structure 1808, here shown as three bearing rods and a retaining plate that are attached, at the proximal end, to the linear drive 1805 and, at the distal end, to the suction plate 1806. The plate 1806 can be of any variety that permits attachment with the surface of upper plate 1714, e.g., to provide coupling between the motor 1804 and the reciprocating nanopipetter plunger assembly 1712 (via linear drive 1805 and rigid support structure 1808). It will be appreciated that structures and configurations other than support 1808 may be used to couple the suction plate 1806 to the motor 1804 so that action of the latter effects linear translation of the former. It will also be appreciated that mechanisms (e.g., hooks, latches, etc.) can be used in place of suction plate 1806 to facilitate reciprocating nanopipetter plunger assembly 1712.

The effector 1802 includes pneumatic latches 1812 (e.g., of the “quick-connect” variety) or other actuators (pneumatic, manual or otherwise) disposed on the effector chassis (particularly, here, by way of non-limiting example, at bottom plate 1810b) which releasably retain rods 1708 on the carrier 1702 and, particularly, fixedly with respect to effector chassis—here, represented by side, bottom and intermediate supports plates 1810a-1810c. The actuators 1812 are supplied by the illustrated pneumatic lines, which may shared, for example, with the pneumatic piston 821.

Illustrated motor 1804 is attached to the chassis of effector 1802 and, particularly, in the illustrated embodiment, to the intermediate plate 1810c. Consequently, linear translation is relative to the effector chassis and, thereby, for example, to its mounting location on the arm 128. It will be appreciated that the effector chassis may comprise structures and configurations other than illustrated plates 1810a-1810c and that the motor 1804 may be coupled, directly or indirectly, to such structures.

Also disposed on bottom plate are apertures 1814. These are sized to permit passage the bearing rods 1715 during mounting of the carrier 1702 by effector 1802.

Operational use of the carrier 1702 and effector 1802 are depicted in FIGS. 18A-18C. For example, as shown in FIG. 18A, the effector 1802 is maneuvered into position over the carrier 1702, e.g., via action of the belt drive assembly.

With reference to FIG. 18B, the effector 1802 is lowered (as indicated by arrow 1820), e.g., via action of the robotic arm 128 bottom support plate 815, extensible section 820 or other portion to which the effector 1802 is coupled. Pneumatic latches or other actuators 1812 capture rods 1708 on the carrier 1702, thereby, coupling the effector 1802 to the carrier 1702 for nanopipette movement and processing.

Concurrent with latching of rods 1708, the suction plate 1806 can be positioned and actuated (as necessary) by pneumatic lines or otherwise for gripping carrier 1702 upper plate 1714. In some embodiments, gripping per se may not be necessary to support downward, compressive movement of the reciprocating nanopipetter plunger assembly. However, in the illustrated embodiment, it is used to facilitate upward, decompressive movement.

With reference to FIG. 18C, the motor 1804 is actuated to reciprocate the upper plate 1714 vis-a-vis the lower plate assembly 1704. In the illustrated embodiment, downward movement of the upper plate 1714 (indicated, here, by arrow 1822) compresses the reciprocating nanopipetter plunger assembly 1712 and, thereby, pushing of the plungers 1716 into their respective nanopipettes and decreasing their working volume. Conversely, upward movement of the plate 1714 decompresses the assembly 1712, pulling the plungers 1716 from within their respective nanopipettes and increasing their working volumes.

Unlike the prior art, in which pipetter-type devices are used to transfer specimens to and from reaction vessels, nanopipettes according to the invention are used as reaction vessels directly. By way of example, two or more liquids or liquid suspensions may be mixed within the nanopipette as follows. The liquids are sequentially drawn into the chamber without an air gap between them. By moving the plunger back and forth (or otherwise agitating the samples), the fluids are very efficiently mixed. This is due to the fact that near the walls of the nanopipetter chamber, the fluids move more slowly than near the center (boundary layer effect). Thus, within the fluid volume, the difference in velocity creates a “churning” which provides effective mixing. This effect is most pronounced with small diameter chambers (high Reynolds number). By way of further example, two or more liquids may be simultaneously processed within the nanopipette as follows. The liquids are drawn into the chamber with a small air gap between them. The gap prevents the fluids from intermingling and contaminating one another. The liquids are then transferred, e.g., to respective reaction vessels or processed directly within the nanopipetters as described elsewhere herein.

By way of further example, samples within the nanopipetters are heated, cooled or other processed thermally by placing the nanopipetters in environments with appropriately controlled temperatures. This may be in the form of air streams, fluid streams, stationary fluids, or solid block contact. Samples may be rapidly thermally cycled by sequentially changing the temperatures of the surrounding environments. To insure that the samples do not move within the nanopipetters, their tips are pressed against a compliant sealing surface so that pressure from expansion or contraction is equalized on both sides of the sample.

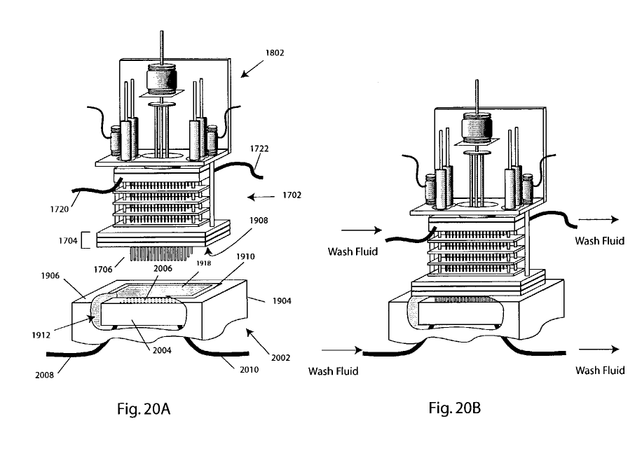

FIG. 19A depicts in cutaway view the general configuration of a processing station 1902 for processing a set of nanopipettes 1706 that are loaded, for example, in a carrier 1702 carried by the effector 1802. The processing station 1902 includes a housing 1904—here, depicted of cuboid shape for simplicity but, generally, being of any shape and size suitable for desired use in conjunction with the workstation 100, e.g., in the manner laboratory equipment or other work pieces 130 depicted in FIG. 4.

Illustrated processing station 1902 has a surface that includes a region 1906 that supports and/or mates with a corresponding surface or region 1908 on the lower plate assembly 1704. The region 1906 includes one or more elastomeric O-rings, gaskets or other sealing members 1910 (elastomeric or otherwise) that facilitate establishing a controlled environment within the processing cavity 1912 of the station 1902, when the carrier 1702 is seated on the station 1902. See, FIG. 19B. Of course, similar sealing member(s) can be provided on surface 1908 instead or in addition.

As shown by the cutaway portion of housing 1906, the cavity 1912 has a surface 1914 including a compliant sealing member 1916, which may be fabricated from an elastomer or other material suitable for sealing the distal tips of the nanopipettes 1706 from undesired specimen, solid, fluid or gas ingress/egress during processing within the station 1902. Illustrated sealing member 1916 is configured to match the overall cross-section or footprint of the nanopipette set 1706, though, other configurations may be used as well.

To facilitate reuse of the sealing member 1916, while minimizing the risk of cross-contaminations, the surface 1906, the cavity opening 1918 thereon and the member 1916 can be sized to permit the carrier 1702 to seat at each of multiple registration positions. This is depicted in FIG. 19C showing black circles at the positions on the member 1916 of the distal tips of a set of nanopipettes 1706 when in a first registration position. The positions of those tips for each of three other registration positions are shown in grey in that drawing. To facilitate achieving any of the one or more registration positions, a registration pin (not shown) can be provided, e.g., on the surface 1908, that mates one or more registration holes (not shown), e.g., on the surface 1906—or vice versa. As the effector 1802 lowers the carrier into position for mating surfaces 1906 and 1908 in each of the registration positions, the registration pin and hole corresponding to that position insure precision mating and prevent accidental motion of the carrier 1702 while it is mated with processing station 1902.

FIG. 20A depicts a wash station 2002 configured in the manner of the processing station shown in FIGS. 19A-19B (as indicated by the use of like reference numbers) and additionally adapted for washing and/or flushing nanopipettes 1706. In place of compliant sealing member 1916, wash station 2002 includes a tip wash element 2004 have a set of apertures 2006 arranged to receive distal tips of the set of nanopipettes 1706 when the carrier 1702 is seated on the station 2002. See, FIG. 20B.

The apertures can be sized to permit slidable reciprocation of the nanopipettes tips with sufficient depth to facilitate (i) wash fluid to be drawn or forced into the respective nanopipettes via their tips, and/or (ii) wash fluid to rinse the tips, e.g., to remove contaminants, upon mating of the carrier 1702 and station 2002. The wash fluid can be contained in common reservoir (not shown) disposed beneath the apertures 2006 and/or in individual fluid supplies associated with each aperture. An inlet and outlet for wash fluid supplied to the element 2004 is indicated by lines 2008, 2010.

Alternative embodiments utilize a depressed region or “wash pan” configuration in addition to, or instead of apertures 2006, to permit gang rinsing of all or multiple groups of nanopipettes tips. This pan, too, can be replenished by lines 2008, 2010.

When it is desired to wash the set of nanopipettes 1706, the effector 1802 is lowered into position on the station 2002 as shown in FIG. 20B. Distilled water or other flush fluid can be introduced (and removed) via lines 1720, 1722 in order to rinse the distal ends of the plungers 1716 and the proximal ends of the nanopipettes 1706. If the fluid in the plenum 1705B is (see FIG. 17B) placed under sufficient pressure, it can be driven out the nanopipettes themselves (e.g., in a manner similar to that shown with respect to the pipettes of FIGS. 13A-13C) for flushing decontaminates there. In that case, flush fluid exiting the nanopipettes can be removed via line 2010.

Alternatively, or in addition, the flush fluid can be introduced and removed via lines 2008, 2010 in order to wash the nanopipette tips. That fluid, too, can be used to flush the nanopipettes, e.g., by retracting the plungers 1716 to draw the fluid into the nanopipettes and extending the plungers to expel the fluid.

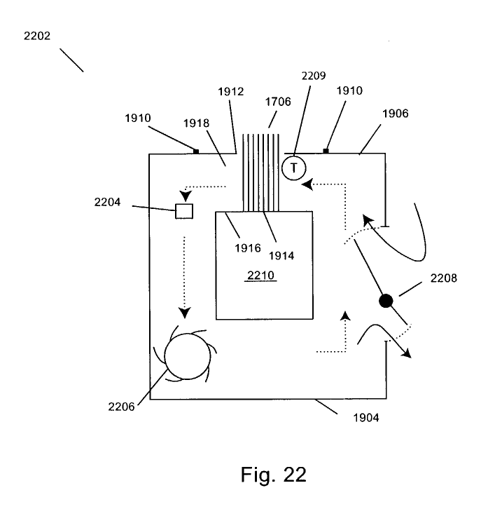

FIG. 22 is a cross-section view of a station 2202 configured in the manner of the processing station shown in FIGS. 19A-19B (again, as indicated by the use of like reference numbers) and additionally adapted for thermal cycling or other processing of nanopipettes 1706. In addition to the elements discussed above in connection with FIGS. 19A-19B, thermal processing station 2202 includes a heater 2204, fan 2206, baffle 2208, and thermocouple 2209, all disposed as indicated vis-a-vis the nanopipettes 1706. Air flows past elements 2204-2209 and around core 2210 in the manner indicated by the dashed-line arrows.

Heater 2204 comprises a resistive coil or other heater of the type commercially available in the marketplace of suitable capacity for raising the temperature within the station 2202 and, more particularly, within the cavity 1918 at a desired rate for processing specimens in the nanopipettes 1706. The heater 2204 is preferably positioned so as not to directly heat the nanopipettes 1706 by radiance but, rather, only by convection travelling in the direction of the air flow. To this end, baffles (not shown) can be disposed between the heater 2204 and nanopipettes 1706 and/or the heater can be positioned so that the direct path between it and the nanopipettes 1706 is blocked, e.g., by the core 2210.

Fan 2206 comprises a paddle wheel-style or other fan of the type commercially available in the marketplace of suitable capacity for moving air heated by the heater 2204, around the core 2210 and through the array of nanopipetters 1706. The fan 2206 is also of capacity to draw environmental air (typically, cooling) in from outside the station 2202 sufficient to cool the nanopipettes 1706 at a desired rate. In the illustrated embodiment, the fan 2206 has a length substantially matching the width of the cavity 1918 at the locale where the fan is disposed. However, it can be substantially shorter than that width, e.g., so long as it capable of suitably moving the heated and/or environmental air.

Baffle 2208 is a conventional baffle that can be set in a closed position to permit recirculation of air, e.g., heated by the heater 2204, contained within the station 2202 and that can be set in one or more open positions to permit environmental air (again, typically cooling) to be drawn in from outside the station 2202. As shown in the drawing, the baffle is configured to permit air (typically, heated) already in the station 2202 to exit at the same time environmental air is drawn in. In the illustrated embodiment, the baffle 2208 is positioned to prevent cooling air directly from reaching the nanopipettes 1706 prior to mixing with air already in the station 2202. To this end, the baffle is positioned sufficiently upstream from the nanopipettes to ensure turbulent mixing of the airs prior to contact with the nanopipettes. Conversely, the nanopipettes 1706 are positioned in an equi-temperature region in the air flow path-i.e., at a location such that the samples within the nanopipettes 1706 are simultaneously exposed to air flows of like or substantially like temperature.

Thermocouple 2209 is a conventional thermocouple or other temperature sensing device of the type commercially available in the marketplace suitable for monitoring temperatures in cavity 1918. The thermocouple is preferably positioned sufficiently near the nanopipettes to measure air temperature flowing past them. Thus, in the illustrated embodiment, the thermocouple 2209 is disposed upstream of the array of nanopipettes, yet, sufficiently downstream from the baffle 2208 to insure that it (the thermocouple) measures temperatures after cooling air introduced by the baffle has been thoroughly mixed with (heated) air already in the station 2202. Of course, in other embodiments, the thermocouple can be positioned at other locations in the station 2202. Moreover, multiple thermocouples can be used, e.g., disposed at different points about the cavity, or otherwise.

Station 2202 and core 2210 are generally shown being of cuboid shape. Those skilled in the art will, of course, appreciate that other shapes may be used instead. Regardless, however, preferred shapes and/or arrangements of components are chosen that, like the illustrated embodiment, result in the nanopipettes 1706 being exposed to thoroughly mixed air flows of like or substantially like temperature.

A further non-limiting example of an application of a nanopipetter according to the invention is the high-throughput processing of small-volume samples for DNA sequencing in connection with the Human Genome Project. The steps in DNA sequencing that can utilize nanopipette technology include but are not limited to aspiration of raw DNA from cells, reagent addition, polymerase chain reaction (PCR) amplification, purification, reagent addition, cycle sequencing, purification, and loading into electrophoresis gels.

By way of still further example, nanopipetters according to the invention are used for separation and purification via processing under influence of a magnetic field. To this end, samples are mixed with ferromagnetic or paramagnetic (collectively, “magnetic”) beads, e.g., of the type available from Dynal, Inc., that bind to selected components in the samples. Mixing can be accomplished prior to introduction of the samples to the nanopipetters or while the samples are within the nanopipetters.

The pipetters and contained samples are placed within a magnetic field, e.g., via placing small, powerful magnets against, surrounding or in close proximity to the outsides of the pipetter chambers. This entrains the magnetic beads and components to which they are bound, attracting and immobilizing them against the inner walls of the chambers. Separation may be accelerated by reciprocating the nanopipetter plungers back and forth so that all portions of the samples pass in close proximity to the magnet or are otherwise exposed to the magnetic field. Care, however, should be taken not to disrupt the beads already entrained by the magnets.

Once the magnetic beads and bound sample components are entrained against the walls of the pipetters, the plunger is retracted and the non-bound portions of the sample pulled away from the entrained or localized portions. Either at the same time or subsequent to plunger retraction, a resuspension fluid is aspirated into the chamber and brought into contact with the beads. This fluid is separated from the original (non-bound) fluid portion of the sample by an air gap. The magnet is then removed and the beads are mixed with the resuspension fluid by back-and-forth plunger motion. The resuspension fluid and beads are then expelled, leaving the non-bound portion of the original sample for dispensing or further processing. Alternatively, the magnet may be replaced, the beads again immobilized and the resuspension fluid expelled.

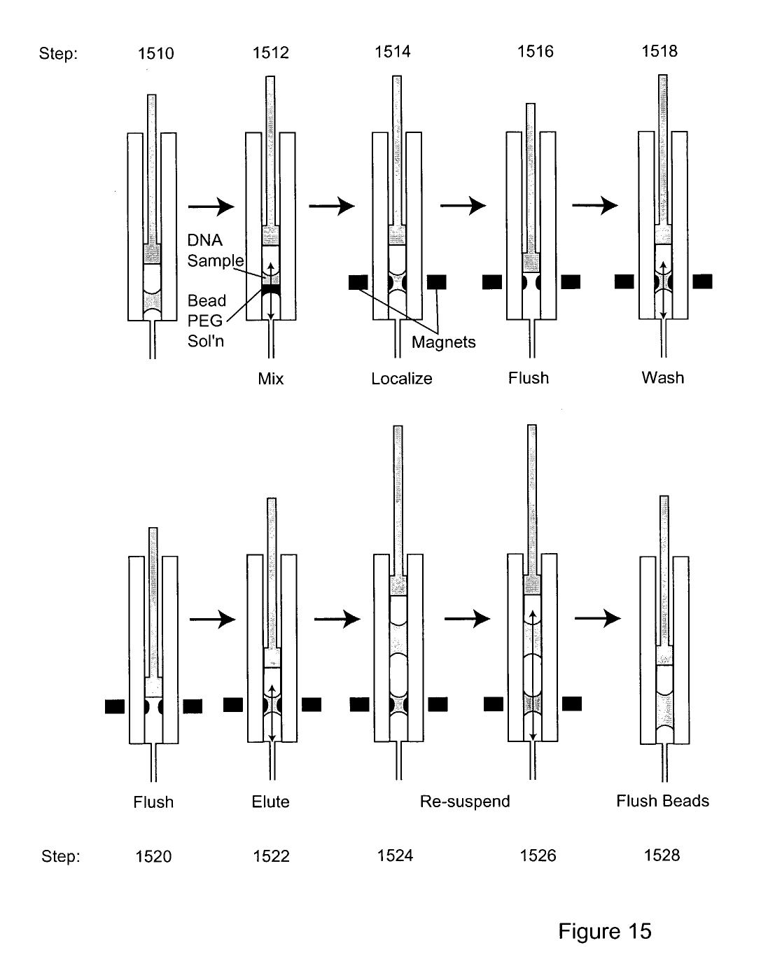

A preferred embodiment of the invention utilizes the above-described nanopipetters in conjunction with magnet manipulation for processing nucleic acid samples in accord with the methodology shown in FIG. 15. To this end, a sample solution containing a nucleic acid, such as DNA, is drawn into a nanopipetter (Step 1510). A second solution containing magnetic beads that will bind to DNA (such as through biotin-streptavidin binding) and a precipitant (such as polyethylene glycol) is also drawn into the nanopipetter preferably without an air gap between the first and second solutions (Step 1512). The two solutions are preferably mixed by reciprocating the plunger (also, Step 1512). The precipitated DNA is thus bound by the magnetic beads.

The magnetic beads are localized to the inner wall of the nanopipetter by placing it against or in close proximity to a strong magnet (Step 1514). The mixed solution without the magnetic beads and the DNA are dispensed from the pipette (Step 1516). Optionally, a solution for washing the DNA sample may be drawn into the nanopipetter while the beads remain localized by the magnet (Step 1518). The wash solution is dispensed after the wash is complete (Step 1520). The wash may be performed with or without localization of the beads by a magnet. If the wash is performed without a magnet, the beads are subsequently localized by the magnet after the wash is complete.

An elution solution is drawn into the nanopipetter to remove the nucleic acid sample from the magnetic beads (Step 1522). The elution step can be performed with or without localization of the beads by a magnet.

After elution of the DNA from the beads, the DNA is separated from the beads by drawing the elution solution further into the nanopipetter or dispensing the solution contained eluted DNA from the pipetter. If the DNA solution is drawn further into the pipetter with an air bubble, another solution can be drawn into the pipette to flush the beads from the pipette (Steps 1524-1528). After flushing the beads, the DNA solution in the pipette can be further processed while inside the pipette.

FIG. 17C depicts an adapter 1724 for use in conjunction with carrier 1702 in order to place the individual pipettes 1706 within magnetic fields, e.g., in order to entrain the magnetic beads and components as discussed above. The adapter comprises a plate 1726 with apertures 1728 that extend partially or, preferably, fully therethrough and that are arranged to receive distal tips of the set of nanopipettes 1706 when the adapter 1724 is mated to the carrier 1702 as shown in FIG. 17D.

A magnetic field extends through each aperture, e.g., in cross-wise direction, sufficient to entrain the beads and components, or as otherwise desired. The field can be provided by individual ring magnets (not shown) disposed about each aperture or group thereof and/or by sets of bar or other magnets (not shown) disposed, e.g., at opposing sides and/or ends of the plate 1726. Regardless of their geometry, the magnets can be of the permanent or electromagnetic variety, the latter permitting the magnetic field to be activated and deactivated without detachment of the adapter 1724 from the carrier 1702. The apertures are sized to permit slidable receipt of the nanopipettes 1706, within expected tolerances, yet at the same time to permit desired containment of the magnetic fields.

Coupling between the carrier 1702 and the adapter 1724 is effected via a pneumatic latch (e.g., of the “quick-connect” variety) or other actuators 1610 (pneumatic, manual or otherwise) on the carrier 1702 (or elsewhere on arm 128), which releasably retains one or more collared rods 1730 disposed on adapter 1724. Four such rods are shown in the illustration, though it will be appreciated that greater or fewer can be employed. Moreover, it will be appreciate that other mechanisms can be employed to retain the adapter on the carrier detachably (as with the illustrated configuration), permanently or otherwise.

In operation, the carrier 1702 is positioned over the adapter 1724 and lowered, via action of the effector 1802 and/or robotic arm 128. Pneumatic latches or other actuators capture rods 1730, coupling the adapter 1724 to the carrier 1702. Alternatively, the adapter 1724 can be placed on the carrier 1702 manually or otherwise. In embodiments where the magnetic fields in the apertures 1728 are effected by permanent magnets, the adapter 1724 and carrier 1702 are coupled whenever it is desirable to apply those fields to the contents of the nanopipettes. Contrariwise, the adapter and carrier are decoupled when such fields are no longer required. In embodiments, in which the magnetic fields are effected by electromagnetic magnets, the adapter 1724 can remain affixed to the carrier and the fields applied by operation of current to the magnets.

A further appreciation of the structure of an apparatus according to the invention may be attained by reference to the Appendix of U.S. patent application Ser. No. 09/419,179, entitled CONTINUOUS PROCESSING AUTOMATED WORKSTATION, filed on Oct. 15, 1999, the teachings of which are incorporated herein by reference and a copy of which Appendix is attached as an appendix hereto, in which Sheet A1 is an exploded perspective view showing of a workstation according to the invention and particularly showing, the cassette storage areas, work area, robotic arm and robotic arm drive mechanisms; Appendix A2 is the front view of a robotic arm according to the invention equipped with a single-pipette end effector with a tip and plate washing apparatus of the type shown in FIG. 10; Appendix A3-A7 are front, top and side view of a robotic arm according to the invention equipped with a basic end effector of the type shown in FIGS. 7-8 and equipped with a twelve-tip pipette of the type shown in FIG. 9; Appendix A8 is a three-dimensional depiction of a twelve-tip pipette of the type shown in FIG. 9. With further reference to Appendix A3-A7, Appendix A5 is a top view of the end effector. Front and side views with the basic end effector retracted are shown in Appendix A3 and A4. Front and side views with the basic end effector extended are shown in Appendix A6 and A7.

Described herein are automated workstations, robotic arms, robotic arm positioning mechanisms, plate handling mechanisms, effector tip/plate washing mechanisms, back-flushing mechanisms, fluid level detection mechanisms, and nanopipetters (or other such apparatus) as well as methods of operation thereof, meeting the objects set forth above. Those skilled in the art will appreciate that the embodiments discussed and illustrated herein are examples of the invention and that other apparatus and methods incorporating equivalents thereof and other changes therein fall within the scope of the invention, of which we claim:

1. In a robotic arm of the type having an effector that is detachably coupled to the arm via a latching mechanism that includes first portion disposed on the effector and a second portion disposed on the arm, the improvement comprising
a release at least one of (i) disposed on the effector separately from the first portion of the latching mechanism and (ii) disposed on the arm separately from the second portion of the latching mechanism,
the release effecting a torque on at least one of the first and second portions of the latching mechanism at least partially countering a torque effected on that portion of the latching mechanism by at least one of the effector and an article carried thereby.

2. In the robotic arm of claim 1, the further improvement wherein the release effects a torque tending to bring the first and second portions of the latching mechanism into alignment for disengagement.

3. In the robotic arm of claim 1, the further improvement wherein the release comprises a rod that stands proud from a surface of any of the arm and effector.

4. In the robotic arm of claim 3, the further improvement wherein the rod is spring-loaded.

5. An effector for use with a robotic arm, the effector comprising
one or more extending forks adapted for handling a specimen or vessel therefor,
a first latching member adapted for releasable engagement with a second latching member on the arm,
a release disposed separately from the first latching member, the release adapted for exerting a force on the arm when the first and second latching members are engaged, the force effecting a torque on the first latching member that at least partially counters a torque effected on that member by at least one of the forks, the specimen, and a vessel therefor.

6. The effector of claim 5, wherein the first latching member comprises an elongate element adapted for releasable engagement by an element on the arm.

7. The effector of claim 5, wherein the release comprises a spring-loaded element.

8. The effector of claim 5, wherein the release comprises a rod that stands proud from a surface of the effector.

9. The effector of claim 5, wherein the release is disposed opposite the first latching member with respect to forks.

10. The effector of claim 5, wherein the release effects a torque that brings the first and second latching members into alignment for disengagement.

11. An effector for use with a robotic arm, the effector comprising
structure adapted for handling a specimen or vessel therefor,
an elongate element adapted for releasable engagement with a latch or other actuator (collectively, “latch”) on the arm,
a release member disposed separately from and independent of the elongate element on an opposite side thereof with respect to the aforesaid structure,
the release member adapted for effecting a torque at least partially countering that effected on the elongate element by the structure or a specimen or vessel handled thereby and, thereby, facilitating release of any engagement therebetween.

12. The effector of claim 11, wherein the release comprises a spring-loaded member disposed on a surface of the effector.

13. The effector of claim 12, wherein the first latching member comprises a rod that stands proud from a surface of the effector.

14. The effector of claim 12, wherein the surface of the effector is one that mates with a surface of the arm.

15. In an automated workstation, the improvement comprising a robotic arm including
a moveable member,
a pneumatic latch or actuator (collectively, “pneumatic latch”) disposed on the moveable member,
an effector,
the effector comprising
a load-carrying structure,
a latching member adapted for releasable engagement with the pneumatic latch,
a release member disposed separately from the latching member,
the release member exerts on the latching member a torque that at least partially counters that effected on the latching member by the load-carrying structure or a load carried thereby.

16. In the automated workstation of claim 15, the further improvement wherein moveable member is coupled to an assembly capable of translating the moveable member in at least two dimensions.

17. In the automated workstation of claim 16, the further improvement wherein the load-carrying structure comprises one or more extending forks.

18. In the automated workstation of claim 16, the further improvement wherein
the latching member comprises an elongate element,
the release member exerts a torque tending to bring the elongate element into line with the pneumatic latch.

19. In the automated workstation of claim 16, the further improvement wherein the release comprises a spring-loaded member.

20. In the automated workstation of claim 19, the further improvement wherein the spring-loaded member stands proud from a surface of the effector.

21. In a robotic arm, the improvement comprising
a wash apparatus comprising one or more apertures, each arranged for receiving one or more respective tips disposed on the arm,
the wash apparatus translating from a first, carrying position in which the apertures are disposed clear of the respective one or more tips to a second, operative position in which the one or more tips are received in the one or more apertures,
such translation of the wash apparatus including rotating from the first position to a third, intermediate position and moving linearly from the third position to the second position.

22. In the robotic arm of claim 21, the further improvement wherein, when the wash apparatus is in the third position, each of the one or more apertures are aligned with one or more respective tips which are to be received therein.

23. In the robotic arm of claim 21, the further improvement wherein the tips are pipette tips and wherein the one or more apertures are arranged for receiving such pipette tips.

24. In the robotic arm of claim 23, the further improvement wherein at least one of the apertures is arranged for receiving the tip of a pipette comprising a thin-walled cylindrical chamber with a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

25. In the robotic arm of claim 21, the further improvement wherein the wash apparatus comprises at least one of an ingress and egress for wash fluid.

26. In the robotic arm of claim 21, further improvement wherein the wash apparatus is disposed on an actuator for motion relative to the tips.

27. A pipetter for use with the robotic arm, comprising
a plurality of pipettes, each having a tip,
a wash apparatus disposed for motion relative to at least the tips, the wash apparatus comprising a plurality of apertures, each arranged for receiving a respective pipette tip,
the wash apparatus translating from a first, carrying position in which the wash apparatus and the apertures are disposed clear of the tips to a second, operative position in which the tips are received in the respective apertures, such translation of the wash apparatus including rotating from the first position to a third, intermediate position and moving linearly from the third position to the second position, wherein the apertures are aligned with their respective tips when the wash apparatus is in the third position,
the wash apparatus having at least one of an ingress and egress for wash fluid.

28. The pipetter of claim 27, wherein at least one of the apertures is arranged for receiving the tip of a pipette comprising a thin-walled cylindrical chamber with a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

29. A pipette carrier for use in an automated workstation, comprising
a pipette having a proximal end and a distal end,
a plunger disposed for motion relative to the pipette,
a first element for at least pushing the plunger toward a distal end of the pipette,
a second element having an aperture in which the plunger is slidably disposed, the aperture being disposed between the first element and the proximal end of the pipette, the aperture being sized to prevent buckling of the plunger when the latter is pushed by the first element.

30. The pipette carrier of claim 29, wherein at least the proximal end of the pipette is disposed within a ferrule that is seated within a third element.

31. The pipette carrier of claim 30, wherein the proximal end of the pipette is disposed within a plenum within the third element.

32. The pipette carrier of claim 31, wherein the third element comprises at least one of an inlet and an outlet for wash fluid.

33. The pipette carrier of claim 29, wherein the aperture is disposed along a desired path of motion of the plunger.

34. The pipette carrier of claim 29, wherein the aperture is sized to permit motion of the plunger without such play as permits buckling of plunger or adversely impact positioning of its distal end.

35. The pipette carrier of claim 29, wherein the pipette comprises a thin-walled cylindrical chamber comprising a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

36. In a pipette carrier of the type for carrying a plurality of pipettes, the improvement comprising
one or more pipettes coupled to a first member,
one or more plungers coupled to a second member,
the first and second members being coupled for motion relative to one another,
a third member disposed between the first and second members for motion relative to at least one of them,
the third member having one or more apertures in each of which one or more plungers are slidably disposed, at least one of the apertures being sized to reduce buckling of the one or more plungers disposed therein when those plungers are pushed.

37. In the pipette carrier of claim 36, the further improvement wherein at least one of plungers is sized to permit motion of the one or more plungers disposed therein without such play as permits buckling of those plungers or otherwise adversely impacts positioning of their distal ends when those plungers are pushed.

38. In the pipette carrier of claim 36, the further improvement wherein at least one of the pipettes is removably mounted to the first member.

39. In the pipette carrier of claim 38, the further improvement wherein at least one of the pipettes is disposed within a ferrule that is seated within the first member.

40. In the pipette carrier of claim 39, the further improvement wherein the proximal end is flanged of a pipette that is disposed within a ferrule.

41. In the pipette carrier claim 36, the further improvement wherein the pipettes are arranged in any of an array or matrix.

42. In the pipette carrier of claim 36, the further improvement wherein at least one of the plungers is removably mounted to the second member.

43. In the pipette carrier of claim 42, the further improvement wherein each plunger has a corresponding pipette, the proximal end into which the distal end of that plunger extends.

44. In the pipette carrier of claim 36, wherein the pipette comprises a thin-walled cylindrical chamber comprising a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

45. In a pipetter for use with a robotic arm, the improvement comprising
a first plate (hereinafter termed “lower” plate) from which a set of pipettes extend,
a plunger assembly that includes
a second plate (hereinafter termed “upper” plate),
a set of plungers mounted in the upper plate, each plunger corresponding to a pipette in the set of pipettes and extending from the upper plate to the corresponding pipette,
the plunger assembly being coupled to the first plate for reciprocating motion with respect thereto,
the plunger assembly further including one or more anti-buckle plates disposed between the upper and lower plates, the one or more anti-buckle plates including apertures through which the plungers are slidably disposed, the apertures being sized to substantially prevent buckling of the plungers.

46. In the pipetter of claim 45, wherein the first plate includes a plenum in which proximal ends of the pipettes are in fluid communication.

47. In the pipetter of claim 46, comprising one or more fluid lines to any of supply wash fluid to and remove wash fluid from the plenum.

48. A pipetter, comprising
a pipette having a proximal end and a distal end,
a plunger disposed for motion relative to the pipette,
a first element for at least pushing the plunger toward a distal end of the pipette,
a second element having an aperture in which the plunger is slidably disposed, the aperture being disposed between the first element and the proximal end of the pipette, the aperture being sized to reduce buckling of the plunger when the latter is pushed by the first element,
an effector comprising a motor that is coupled to at least one of the first and second elements for moving at least one of the plunger and the pipette relative to the other.

49. A pipetter, comprising
a pipette having a proximal end and a distal end,
a plunger disposed for motion relative to the pipette,
an aperture in which the plunger is slidably disposed, the aperture being sized to reduce buckling of the plunger when the latter pushed relative to the pipette.

50. A pipetter of claim 49, comprising a motor for moving the plunger and the pipette relative to the other.

51. A pipetter of claim 50, comprising a suction member providing coupling between the motor and at least one of the plunger and the pipette.

52. A pipetter of claim 51, wherein the suction member is a suction cup.

53. A pipette carrier of claim 52, wherein the pipette comprises a thin-walled cylindrical chamber comprising a body having a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

54. A pipetter for use with a robotic arm, the pipetter comprising
a nanopipette carrier including
one or more nanopipettes coupled to a first plate-like member, at least one nanopipette comprising a thin-walled cylindrical chamber having a body with a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters,
one or more plungers coupled to a second plate-like member,
a third plate-like member disposed between the first and second members for motion relative to at least one of them,
the third plate-like member having one or more apertures in each of which one or more plungers are slidably disposed, at least one of the apertures being sized to reduce buckling of the one or more plungers disposed therein when those plungers are pushed,
an effector that is coupled to the carrier by way of at least a suction member, the effector for at least pushing the plungers relative to the nanopipettes.

55. The pipetter of claim 54, wherein the suction member comprises a suction cup arranged for releasable coupling to the second plate-like member.

56. The pipetter of claim 54, wherein the effector is coupled to the robotic arm.

57. The pipetter of claim 54, wherein the effector comprises a motor that is coupled with any of the first and second plate-like members.

58. The pipetter of claim 57, wherein the motor is arranged for at least one of pushing and pulling the plungers relative to the nanopipettes.

59. The pipetter of claim 58, wherein the nanopipette carrier is releasably coupled to the effector.

60. The pipetter of claim 58 comprising a fourth plate-like member that is coupled to the carrier, the fourth plate-like member providing a magnetic field for one or more of the nanopipettes.

61. The pipetter of claim 60, wherein the fourth plate-like member comprises one or more apertures arranged to receive distal tips of each of one or more nanopipettes, each aperture having an associated magnetic field source.

62. The pipetter of claim 60, wherein the fourth plate-like member is releasably attached to the carrier.

63. A processing station for use with a pipetter effector, comprising
a housing defining a cavity arranged to receive a set of nanopipettes carried by the pipetter effector,
the housing having a surface that at least one of supports and couples with effector,
the cavity having a surface including a sealing member arranged for sealing distal tips of nanopipettes received in the cavity.

64. The processing station of claim 63, wherein the cavity is sized to receive the set of nanopipettes at multiple registration positions.

65. The processing station of claim 64, wherein the housing surface includes at least one of a hole and a pin defining at least one said registration position.

66. The processing station of claim 65, wherein the at least one hole and pin is arranged to mate with structure on the pipetter effector.

67. The processing station of claim 63, wherein the first surface comprises an environmental sealing member that mates with the effector.

68. A processing station for use with a pipetter effector, comprising
a housing defining a cavity arranged to receive a set of nanopipettes carried by the pipetter effector,
the cavity having a wash member with one or more apertures arranged for receiving nanopipettes in the cavity, and
the wash member having a medium for washing one or more nanopipettes received by the wash member.

69. The processing station of claim 68, wherein the wash member comprises a reservoir for the medium.

70. The processing station of claim 68, wherein the wash member comprises a plurality of apertures, each for receiving a respective one of the nanopipettes.

71. The processing station of claim 68, wherein the wash member comprises at least one of an inlet and an outlet for the wash medium.

72. In a thermal processing station for use with a pipetter effector, the improvement comprising
a cavity arranged to receive one or more pipettes,
an airflow path that includes at least a portion of the cavity in which the pipettes are received,
the cavity being arranged with respect to the airflow path such that pipettes received in the cavity are exposed to an equi-temperature airflow.

73. In the thermal processing station of claim 72, the further improvement comprising a heater and a fan disposed, the heater and fan being arranged for generating a heated airflow along the airflow path.

74. In the thermal processing station of claim 73, the further improvement wherein the heater is positioned so as not to directly heat the pipettes by radiance.

75. In the thermal processing station of claim 74, the further improvement comprising baffles disposed between the heater and the pipettes.

76. In the thermal processing station of claim 73, the further improvement wherein the fan is a paddle wheel-style fan.

77. In the thermal processing station of claim 73, the further improvement comprising a baffle that can be set in one or more positions to permit at least one of environmental and cooling air to be drawn into the airflow path.

78. In the thermal processing station of claim 77, the further improvement wherein the baffle can be set in a position to permit recirculation of air.

79. In the thermal processing station of claim 73, the further improvement comprising a temperature-sensing device arranged for measuring a temperature of the airflow.

80. In the thermal processing station of claim 79, the further improvement wherein the temperature-sensing device is arranged for measuring a temperature of the airflow in a vicinity of the pipettes.

81. In the thermal processing station of claim 72, the further improvement wherein one or more of the pipettes comprise a thin-walled cylindrical chamber having a body with a wall defining a cavity, the cavity having an average diameter substantially equal to or under any of 1000 microns, 750 microns, 500 microns and 250 microns, the wall having an average thickness substantially equal to or under any of 1000 microns, 750 microns, 500 microns and 250 microns, the body holding a fluid volume substantially equal to or under any of 10 microliters, 1 microliter, 100 nanoliters, 50 nanoliters, and under 10 nanoliters.

82. A thermal processing station for use with a pipetter effector, comprising
a housing defining a cavity arranged to receive a set of nanopipettes carried by the pipetter effector,
an airflow path that includes at least a portion of the cavity in which the nanopipettes are received,
a heater for heating an airflow in the airflow path,
a baffle that selectively permits at least one of environmental and cooling air to be drawn into the airflow path,
a thermocouple arranged for measuring a temperature of the airflow,
the cavity being arranged with respect to the airflow path such that pipettes received in the cavity are exposed to an equi-temperature airflow.
